(19) United States
(12) Patent Application Publication
(10) Pub. No.: US 2026/0221912 A1
(43) Pub. Date: Jul. 30, 2026

(54) MOTOR DRIVE CONTROL DEVICE AND MOTOR DRIVE CONTROL METHOD

(71) Applicant: MINEBEA MITSUMI Inc., Kitasaku-gun, Nagano (JP)

(72) Inventors: Hiroki KOKUBO, Kitasaku-gun, Nagano (JP); Shinji TOTSUKA, Kitasaku-gun, Nagano (JP); Hidetoshi HIJIKATA, Kitasaku-gun, Nagano (JP); Shigemi MASUDA, Kitasaku-gun, Nagano (JP)

(21) Appl. No.: 19/148,777

(22) PCT Filed: Nov. 27, 2023
(86) PCT No.: PCT/JP2023/042357

§ 371 Date: Jul. 17, 2025

(30) Foreign Application Priority Data
Jan. 23, 2023 (JP) 2023-008274

(51) Int. Cl. H02P 21/22; H02P 21/24; H02P 27/06

(52) U.S. Cl. CPC H02P 21/22; H02P 21/24; H02P 27/06; H02P 2207/05

(57) ABSTRACT

To reduce a computation load in motor drive control. In a motor drive control device, a control circuit is configured to detect, as a peak value, a phase current closest to a q-axis current when a d-axis current is set to 0 among phase currents flowing through coils of respective phases and phase currents obtained by inverting the phases of the phase currents by 180° and calculates the q-axis current when the d-axis current is set to 0, on the basis of an envelope of the peak value, generate a drive control signal by performing a vector control computation by using the q-axis current calculated, a drive command signal, a rotation speed, and a rotation angle.

### TECHNICAL FIELD

The present invention relates to a motor drive control device and a motor drive control method.

### BACKGROUND ART

In general, permanent magnet synchronous motors (PMSMs) serving as brushless DC motors are roughly classified into a surface permanent magnet synchronous motor (SPMSM) having a permanent magnet attached to the surface of a rotating element, and an interior permanent magnet synchronous motor (IPMSM) having a permanent magnet embedded in a rotating element.

In the related art, as a drive control technique of a permanent magnet synchronous motor (PMSM), a motor drive control method based on vector control is known (for example, see Patent Document 1).

### CITATION LIST

### Patent Literature

Patent Document 1: JP 2012-130100 A

### SUMMARY OF INVENTION

### Technical Problem

However, in the motor drive control method based on the vector control, complicated computations such as coordinate conversion and division between a fixed coordinate system and a rotating coordinate system need to be performed, resulting in an increase in a computation load at a program processing device such as a microcontroller serving as a motor drive control device. Therefore, a high-performance microcontroller and the like provided with a large-capacity memory and capable of processing complicated computations at high speed are required, resulting in an increase in the cost of the motor drive control device.

The present invention is contrived for solving the above-mentioned problems, and an object of the present invention is to reduce a computation load in motor drive control.

### Solution to Problem

A motor drive control device according to a representative embodiment of the present invention includes: a control circuit configured to output a drive control signal for driving a motor having multiphase coils; and a drive circuit configured to drive the motor on the basis of the drive control signal output from the control circuit. The drive circuit includes: an inverter circuit configured to drive the multiphase coils on the basis of the drive control signal; and a current detection circuit configured to detect a current flowing through the multiphase coils and to output a current detection signal corresponding to the detected current. The control circuit includes: a drive command acquisition unit configured to acquire a drive command signal including a value indicating a target state of an operation of the motor; a q-axis current calculation unit configured to detect, as a peak value, a phase current closest to a q-axis current of a two-phase rotating coordinate system when a d-axis current of the two-phase rotating coordinate system is set to 0 among phase currents flowing through the coils of respective phases and phase currents obtained by inverting the phases of the phase currents flowing through the coils of respective phases by 180°, on the basis of the current detection signal and a rotation angle of a rotor of the motor, and to calculate the q-axis current when the d-axis current is set to 0, on the basis of an envelope of the peak value; and a computation unit configured to generate the drive control signal by performing a vector control computation by using the q-axis current calculated by the q-axis current calculation unit, the drive command signal, a rotation speed of the rotor of the motor, and the rotation angle of the rotor.

### Advantageous Effects of Invention

According to an aspect of the present invention, a computation load in motor drive control can be reduced.

### BRIEF DESCRIPTION OF DRAWINGS

FIG. 1 is a diagram illustrating a configuration of a motor unit including a motor drive control device according to a first embodiment.

FIG. 2 is a diagram illustrating a functional block configuration of a control circuit in the motor drive control device according to the first embodiment.

FIG. 3 is a diagram illustrating a relationship between a three-phase fixed coordinate system and a two-phase rotating coordinate system.

FIG. 4 is a diagram illustrating current vectors in a two phase rotating coordinate system.

FIG. 5 is a diagram illustrating a relationship between a phase current of each phase of a motor and a q-axis current.

FIG. 6 is a diagram illustrating an example of a positive q-axis current and phase currents.

FIG. 7 is a diagram illustrating an example of a negative q-axis current and phase currents.

FIG. 8 is a diagram showing a correspondence relationship between sectors and phase currents serving as candidates for a peak value.

FIG. 9 is a diagram illustrating a configuration example of a peak value detection unit according to the first embodiment.

FIG. 10 is a diagram for explaining a current delay with respect to a voltage applied to a coil of a motor.

FIG. 11 is a diagram for explaining a method of calculating a lead angle value.

FIG. 12 is a diagram showing an example of a table as correspondence relationship information with a lead angle value associated with each of combinations of rotation speeds and q-axis currents.

FIG. 13 is a flowchart illustrating an example of the flow of a process for generating a drive control signal by the motor drive control device according to the first embodiment.

FIG. 14 is a flowchart illustrating an example of the flow of a process (step S5) of calculating a q-axis current according to the first embodiment.

FIG. 15 is a diagram illustrating a functional block configuration of a control circuit in a motor drive control device according to a second embodiment.

FIG. 16 is a diagram for explaining a shift of a current vector caused by a shift of an estimated value from a true value of a rotation angle of a rotor.

FIG. 17 is a diagram for explaining an overview of a method of estimating a q-axis current according to the second embodiment.

FIG. 18A is a diagram showing an example of a correspondence relationship between sectors and phase currents serving as candidates for a peak value in the second embodiment.

FIG. 18B is a diagram showing an example of a correspondence relationship between sectors and phase currents serving as candidates for a peak value in the second embodiment.

FIG. 19 is a diagram illustrating a configuration example of a peak value detection unit according to the second embodiment.

FIG. 20 is a flowchart illustrating an example of the flow of a process (step S5) of calculating a q-axis current in the second embodiment.

FIG. 21 is a diagram illustrating a functional block configuration of a control circuit in a motor drive control device according to a third embodiment.

FIG. 22 is a diagram illustrating a relationship between a current vector and a voltage vector in a two-phase rotating coordinate system.

FIG. 23 is a diagram illustrating a configuration example of a peak value detection unit according to the third embodiment.

FIG. 24 is a diagram for explaining an overview of a method of estimating a q-axis current according to the third embodiment.

FIG. 25A is a diagram illustrating an example of a correspondence relationship between sectors and phase currents serving as candidates for a peak value in the third embodiment.

FIG. 25B is a diagram illustrating an example of a correspondence relationship between sectors and phase currents serving as candidates for a peak value in the third embodiment.

### DESCRIPTION OF EMBODIMENTS

### 1. Overview of Embodiments

First, a representative embodiment of the invention disclosed in the present application is overviewed. In the following description, as an example, reference signs in the drawings corresponding to components of the invention are indicated in parentheses.

[1] A motor drive control device (10, 10A, 10B) according to a representative embodiment of the present invention includes: a control circuit (1, 1A, 1B) configured to output a drive control signal (Sd) for driving a motor (3) including multiphase coils (Lu, Lv, Lw); and a drive circuit (2) configured to drive the motor on the basis of the drive control signal output from the control circuit. The drive circuit includes: an inverter circuit (2a) configured to drive the multiphase coils on the basis of the drive control signal; and a current detection circuit (2c) configured to detect a current flowing through the multiphase coils and to output a current detection signal (Vm) corresponding to the detected current. The control circuit includes: a drive command acquisition unit (11) configured to acquire a drive command signal (Sc, Sc1) including a value indicating a target state of an operation of the motor; a q-axis current calculation unit (12, 12A, 12B) configured to detect, as a peak value (ip), a phase current closest to a q-axis current of a two-phase rotating coordinate system when a d-axis current of the two-phase rotating coordinate system is set to 0 among phase currents (iu, iv, iw) flowing through the coils of respective phases and phase currents (−iu, −iv, −iw) obtained by inverting the phases of the phase currents flowing through the coils of respective phases by 180°, on the basis of the current detection signal and a rotation angle of a rotor (31) of the motor, and to calculate the q-axis current (iq) when the d-axis current is set to 0, on the basis of an envelope of the peak value; and a computation unit (13) configured to generate the drive control signal by performing a vector control computation by using the q-axis current calculated by the q-axis current calculation unit, the drive command signal, a rotation speed of the rotor of the motor, and the rotation angle of the rotor.

[2] In the motor drive control device according to [1] above, the control circuit may store correspondence relationship information (128, 128A_1, 128A_2, 128B_1, 128B_2) including sectors (I to VI) respectively associated with phase currents serving as candidates for the peak value, the sectors being obtained by dividing a range of an electrical angle according to a rotation of the rotor into a plurality of sub-ranges, and the q-axis current calculation unit may detect a phase of a current vector in the two-phase rotating coordinate system on the basis of the rotation angle of the rotor and the current detection signal, specify the sector including the phase of the current vector, select a candidate phase current associated with the specified sector on the basis of the correspondence relationship information, and set the selected phase current as the peak value.

[3] In the motor drive control device (10A, 10B) according to [2] above, when a plurality of candidate phase currents of the peak value are associated with the sectors, the q-axis current calculation unit (12A, 12B) may compare absolute values of magnitudes of the plurality of candidate phase currents with each other, and set a phase current having a largest absolute value as the peak value.

[4] In the motor drive control device (10. 10A) according to [2] or [3] above, the q-axis current calculation unit (12, 12A) may set a rotation angle obtained by adding π/2 to the rotation angle (θ) of the rotor as the phase of the current vector.

[5] In the motor drive control device (10B) according to [2] or [3] above, the q-axis current calculation unit (12B) may detect the phase of the current vector on the basis of a phase (a) of a voltage vector in the two-phase rotating coordinate system, the phase of the voltage vector being calculated on the basis of the rotation angle of the rotor.

[6] In the motor drive control device according to any one of [1] to [5] above, the q-axis current calculation unit (12, 12A, 12B) may include: a peak value detection unit (121, 121A, 121B) configured to detect the peak value on the basis of the rotation angle of the rotor and the current detection signal; a low-pass filter (122) configured to receive the peak value input and detected by the peak value detection unit; and a multiplication unit (123) configured to multiply a value output from the low-pass filter by a predetermined value, and to output a multiplication result as the q-axis current.

[7] In the motor drive control device according to [6] above, the predetermined value may be π/3.

[8] In the motor drive control device according to [2] above, the sector may be a range obtained by dividing a range of an electrical angle from 0° to 360° for every 60°.

[9] A motor drive control method according to a representative embodiment of the present invention includes: a first step (S1) of acquiring a drive command signal including a value indicating a target state of an operation of a motor including multiphase coils; a second step (S4) of detecting currents flowing through the multiphase coils; a third step (S5) of detecting, as a peak value, a phase current closest to a q-axis current of a two-phase rotating coordinate system when a d-axis current of the two-phase rotating coordinate system is set to 0 among phase currents flowing through the coils of respective phases and phase currents obtained by inverting the phases of the phase currents flowing through the coils of respective phases by 180°, on the basis of the currents detected in the second step and a rotation angle of a rotor of the motor, and calculating the q-axis current when the d-axis current is set to 0, on the basis of an envelope of the peak value; and a fourth step (S6 to S9) of generating a drive control signal for driving the motor by performing a vector control computation by using the drive command signal acquired in the first step, the q-axis current calculated in the third step, a rotation speed of the rotor of the motor, and the rotation angle of the rotor.

### 2. Specific Examples of Embodiments

Specific examples of embodiments of the present invention are described below with reference to the drawings. In the following description, the same reference signs are used for common components in the respective embodiments, and repeated descriptions are omitted.

### First Embodiment

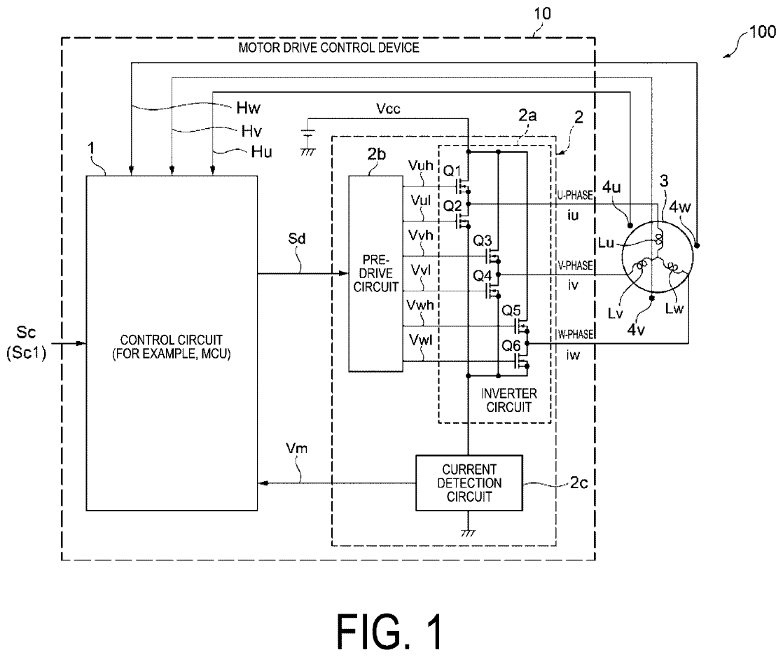

FIG. 1 is a diagram illustrating a configuration of a motor unit 100 including a motor drive control device 10 according to a first embodiment.

As illustrated in FIG. 1, the motor unit 100 includes a motor 3 and the motor drive control device 10 for controlling the rotation of the motor 3. The motor unit 100 can, for example, be applied to various devices using a motor as a driving source such as a fan.

The motor 3 is a permanent magnet synchronous motor (PMSM), for example. In the present embodiment, the motor 3 is, for example, a surface permanent magnet synchronous motor (SPMSM) including three-phase coils Lu, Lv, and Lw. The coils Lu, Lv, and Lw are Y-connected to each other, for example.

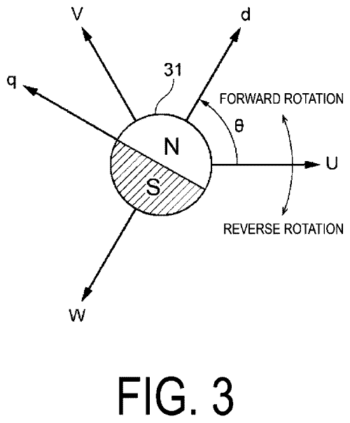

The motor drive control device 10, for example, applies a sinusoidal driving signal to the motor 3 to allow a sinusoidal phase current to periodically flow through the three-phase coils Lu, Lv, and Lw of the motor 3, thereby rotating a rotor 31 of the motor 3 (see FIG. 3).

The motor drive control device 10 includes a control circuit 1 and a drive circuit 2.

Note that the components of the motor drive control device 10 illustrated in FIG. 1 are a part of the whole, and the motor drive control device 10 may include other components in addition to the components illustrated in FIG. 1.

The drive circuit 2 drives the motor 3 on the basis of a drive control signal Sd output from the control circuit 1 to be described below. The drive circuit 2 includes, for example, an inverter circuit 2a, a pre-drive circuit 2b, and a current detection circuit 2c.

The inverter circuit 2a is a circuit arranged between a DC power supply Vcc and a ground potential and drives the multiphase coils Lu, Lv, and Lw of the motor 3 serving as a load on the basis of the input drive control signal Sd. Specifically, in the first embodiment, the inverter circuit 2a includes three switching legs each including two drive transistors connected in series, and drives the motor 3 serving as a load with the two drive transistors alternately performing an on/off operation (switching operation) on the basis of the input drive control signal Sd.

More specifically, the inverter circuit 2a includes switching legs corresponding to the U-phase, V-phase, and W-phase of the motor 3, respectively. As illustrated in FIG. 1, the switching legs corresponding to the phases include two drive transistors Q1 and Q2, two drive transistors Q3 and Q4, and two drive transistors Q5 and Q6 connected in series between the DC power supply Vcc and the ground potential via the current detection circuit 2c, respectively.

The drive transistors Q1, Q3, and Q5 are N-channel MOSFETs, for example, and the drive transistors Q2, Q4, and Q6 are N-channel MOSFETs, for example. The drive transistors Q1 to Q6 may be other types of transistors such as an insulated gate bipolar transistor (IGBT).

For example, the switching leg corresponding to the U-phase includes the drive transistors Q1 and Q2 connected in series with each other. The point connected commonly with the drive transistor Q1 and the drive transistor Q2 is connected to one end of the coil Lu serving as a load. The switching leg corresponding to the V-phase includes the drive transistors Q3 and Q4 connected in series with each other. The point connected commonly with the drive transistor Q3 and the drive transistor Q4 is connected to one end of the coil Lv serving as a load. The switching leg corresponding to the W-phase includes the drive transistors Q5 and Q6 connected in series with each other. The point commonly connected with the drive transistor Q5 and the drive transistor Q6 is connected to one end of the coil Lw serving as a load.

The pre-drive circuit 2b generates a drive signal for driving the inverter circuit 2a on the basis of the drive control signal Sd output from the control circuit 1.

The drive control signal Sd is a signal for controlling driving of the motor 3 and is, for example, a pulse width modulation (PWM) signal. Specifically, the drive control signal Sd is a signal for switching the energization pattern of the coils Lu, Lv, and Lw of the motor 3 determined by the on/off states of the respective drive transistors constituting the inverter circuit 2a. More specifically, the drive control signal Sd includes six types of PWM signals corresponding to the drive transistors Q1 to Q6 of the inverter circuit 2a.

The pre-drive circuit 2b generates six types of drive signals Vuh, Vul, Vvh, Vvl, Vwh, and Vwl for supplying power enough to drive control electrodes (gate electrodes) of the respective drive transistors Q1 to Q6 of the inverter circuit 2a, on the basis of the six types of PWM signals serving as the drive control signal Sd supplied from the control circuit 1.

The respective drive transistors Q1 to Q6 perform on/off operations (switching operations) by receiving the drive signals Vuh, Vul, Vvh, Vvl, Vwh, and Vwl through the control electrodes (gate electrodes) of the respective drive transistors Q1 to Q6 of the inverter circuit 2a. For example, the drive transistors Q1, Q3, and Q5 at an upper arm and the drive transistors Q2, Q4, and Q6 at a lower arm of the switching legs corresponding to the phases alternately perform on/off operations. Thus, the DC power supply Vcc supplies power to each of the phases of the motor 3 to rotate the motor 3.

When the control circuit 1 can generate the drive signals Vuh, Vul, Vvh, Vvl, Vwh, and Vwl, the drive circuit 2 may not include the pre-drive circuit 2b.

The current detection circuit 2c is a circuit for detecting currents flowing through the multiphase coils Lu, Lv, and Lw of the motor 3. The current detection circuit 2c detects currents (phase currents) iu, iv, and iw flowing through the multiphase coils Lu, Lv, and Lw, and outputs a current detection signal Vm corresponding to the detected currents.

The current detection circuit 2c is connected in series with the inverter circuit 2a, for example, and outputs a signal indicating the phase currents iu, iv, and iw of the coils Lu, Lv, and Lw as the current detection signal Vm.

Specifically, the current detection circuit 2c includes at least one resistor (shunt resistor) serving as a current detection element. The shunt resistor is connected in series with the inverter circuit 2a, for example, between the DC power supply Vcc and the ground potential (1-shunt method). In the first embodiment, the shunt resistor serving as the current detection circuit 2c is connected to a negative side (ground side) of the inverter circuit 2a, for example. The current detection circuit 2c converts the phase currents iu, iv, and iw of the coils Lu, Lv, and Lw of the motor 3 into a voltage by the above resistor, and inputs the voltage to the control circuit 1 as the current detection signal Vm. Thus, the current detection signal Vm serves as a signal indicating the phase currents iu, iv, and iw of the coils Lu, Lv, and Lw.

A position sensor 4 is a device for detecting the rotation position of the rotor 31 of the motor 3. The position sensor 4 outputs a signal corresponding to the rotation position of the rotor 31. The position sensor 4 is, for example, a Hall element. FIG. 1 illustrates, as an example, Hall elements serving as position sensors 4u, 4v, and 4w being respectively provided for the U-phase, V-phase, and W-phase of the motor 3. Hereinafter, the position sensors 4u, 4v, and 4w are also referred to as “Hall elements 4u, 4v, and 4w”.

For example, the Hall elements 4u, 4v, and 4w are arranged around the rotor (rotating element) 31 of the motor 3 at substantially equal intervals (for example, at an interval of 120° between adjacent Hall elements). The Hall elements 4u, 4v, and 4w detect a magnetic pole of the rotor 31, and output Hall signals having a voltage, and this voltage fluctuates in accordance with the rotation of the rotor 31, as rotation position detection signals Hu, Hv, and Hw, respectively. The rotation position detection signals Hu, Hv, and Hw are input to the control circuit 1.

Note that the control circuit 1 may be configured to receive, instead of the Hall signal, another signal corresponding to the rotation position of the rotor 31 of the motor 3 as the rotation position detection signal. For example, an encoder, a resolver or the like may be provided such that the detection signal is input to the control circuit 1.

The control circuit 1 generates the drive control signal Sd for driving the motor 3 on the basis of, for example, an externally input drive command signal Sc indicating the target state of the operation of the motor 3, and controls the driving of the motor 3. Specifically, the control circuit 1 monitors the rotation state of the motor 3 by obtaining information on the rotation speed, torque, or the like of the rotor 31 of the motor 3 on the basis of the current detection signal Vm from the current detection circuit 2c and the rotation position detection signals Hu, Hv, and Hw from the position sensors 4u, 4v, and 4w, and also generates the drive control signal Sd in order for the motor 3 to transition to an operation state specified by the drive command signal Sc, and provides the drive command signal Sc to the drive circuit 2.

In the first embodiment, the control circuit 1 is, for example, a program processing device (for example, a micro controller) having a configuration with a processor such as a CPU, various storage devices such as a RAM and a ROM, and peripheral circuits, such as a counter (timer), an A/D conversion circuit, a D/A conversion circuit, a clock generation circuit, and an input/output I/F circuit, connected to one another through a bus or a dedicated line.

In the motor drive control device 10, the control circuit 1 and the drive circuit 2 may be packaged as individual integrated circuit devices, or at least a part of the control circuit 1 and at least a part of the drive circuit 2 may be packaged as one integrated circuit device (IC).

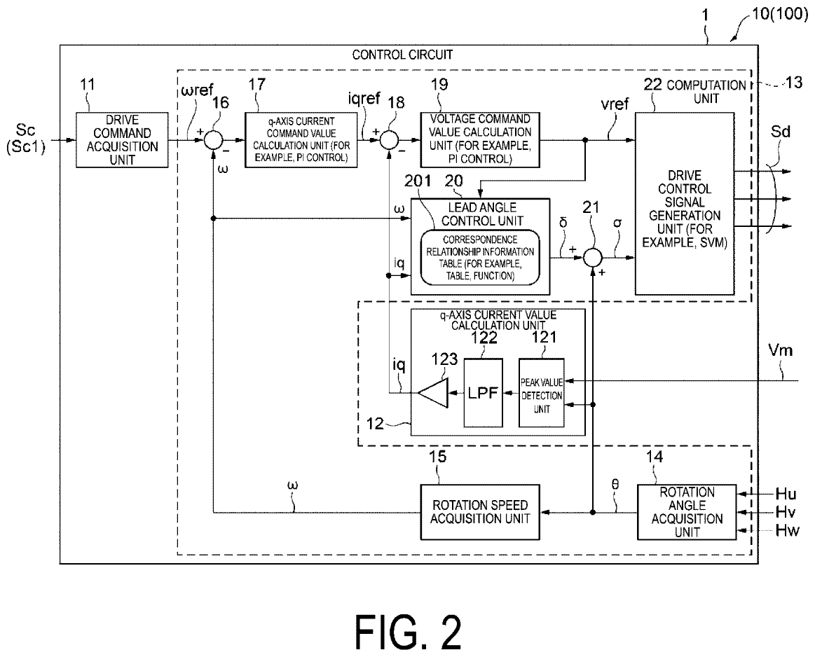

FIG. 2 is a diagram illustrating a functional block configuration of the control circuit 1 in the motor drive control device 10 according to the first embodiment.

As illustrated in FIG. 2, the control circuit 1 includes a drive command acquisition unit 11, a q-axis current calculation unit 12, and a computation unit 13 as functional blocks for generating the drive control signal Sd.

The functional blocks are implemented when the processor performs various computation processes in accordance with programs stored at a memory and controls the peripheral circuits such as the counter and the A/D conversion circuit in the program processing device serving as the control circuit 1, for example. At least a part of the function blocks may be implemented by a dedicated hardware logic circuit.

The drive command acquisition unit 11 receives the drive command signal Sc from the outside, and analyzes the received drive command signal Sc to acquire a value defining a target operation state of the motor 3 specified by the drive command signal Sc.

The drive command signal Sc includes a value indicating the target operation state of the motor 3. The drive command signal Sc is, for example, a signal output from a host device configured to control the motor unit 100 and provided outside the motor drive control device 10.

In the first embodiment, the drive command signal Sc is, for example, a speed command signal Sc1 specifying the rotation speed of the rotor of the motor 3. The drive command signal Sc includes a value ωref of a targeted rotation speed (target rotation speed) of the rotor of the motor 3. Hereinafter, in the first embodiment, description is given under the assumption that the drive command signal Sc is the speed command signal Sc1.

The speed command signal Sc1 is, for example, a PWM signal having a duty ratio according to a specified target rotation speed ωref. For example, the drive command acquisition unit 11 measures the duty ratio of the PWM signal serving as the speed command signal Sc1, and outputs, as the target rotation speed ωref, a rotation speed according to the measured duty ratio.

The q-axis current calculation unit 12 is a functional unit calculating a q-axis current in a two-phase rotating coordinate system on the basis of the phase currents iu, iv, and iw of the coils Lu, Lv, and Lw of the motor 3.

In order to reduce a computation load in the vector control of the motor in the related art, the q-axis current calculation unit 12 calculates the q-axis current by a simple method and generates the drive control signal Sd. A method of calculating the q-axis current is described below.

First, the coordinate system in the vector control by the motor drive control device 10 according to the first embodiment is described.

FIG. 3 is a diagram illustrating a relationship between a three-phase (U, V, and W) fixed coordinate system and a two-phase (d and q) rotating coordinate system.

As illustrated in FIG. 3, the U-V-W axes are a three-phase fixed coordinate system and the d-q axes are a two-phase rotating coordinate system. In general, in the vector control of a motor, the d-axis in the two-phase (d, q) rotating coordinate system is set to a magnetic flux direction (N pole direction) of a permanent magnet serving as a rotor, and the q-axis is set to a direction advanced by 90° (π/2) in a forward direction from the d-axis.

When the directions of the q-axis and the d-axis are set in this way, as illustrated in FIG. 3, a rotation angle θ of the rotor 31 measured by a rotation angle acquisition unit 14 is the rotation angle of the d-axis, for example, an angle between the U-axis and the d-axis in the three-phase (U, V, W) fixed coordinate system.

In general, the torque of a permanent magnet synchronous motor (PMSM) is known to be represented by the following equation.

$$\begin{matrix}[ Mathematical Expression 1 ] & \\ {T}_{e} = P ( Ψ {i}_{q} + ( {L}_{d} - {L}_{q} ) {i}_{d} {i}_{q} ) & ( 1 )\end{matrix}$$

In Equation (1) above, Te is a generated torque, P is the number of pole pairs, Ψ is the magnetic flux of a permanent magnet (rotor), Ld is a d-axis inductance, Lq is a q-axis inductance, id is a d-axis current, iq is a q-axis current, Ψiq is a magnet torque, and “(Ld−Lq) idiq” is a reluctance torque.

When the motor 3 is a surface permanent magnet synchronous motor (SPMSM), since the d-axis inductance Ld and the q-axis inductance Lq are equal to each other (Ld=Lq), no reluctance torque is generated. Accordingly, as can be understood from Equation (1) above, the efficiency of the motor 3 can be maximized when the d-axis current id is set to 0.

The relationship between the phase current of each phase of the motor 3 and the q-axis current of the two-phase rotating coordinate system is described below.

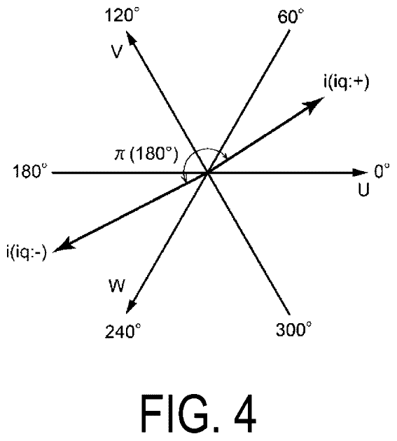

FIG. 4 is a diagram illustrating a current vector i in the two-phase (d, q) rotating coordinate system.

The current vector i of the two-phase (d, q) rotating coordinate system is formed by a d-axis current component and a q-axis current component. When the d-axis current is 0, the current vector i matches the vector of the q-axis current. As illustrated in FIG. 3, when the rotor 31 rotates in the forward direction, the q-axis current is positive.

On the other hand, when the rotor 31 rotates in the reverse direction, the q-axis current is negative. That is, the phase of the current vector during the reverse rotation is shifted by 180° (π) from the phase of the current vector during the forward rotation. In other words, when the rotor 31 is rotated in the reverse direction, the q-axis current needs to be negative. In addition, even when the q-axis current is controlled to be 0 or minute, the q-axis current may be negative due to the influence of noise caused by voltage fluctuation, load fluctuation, or the like.

The case where the q-axis current is controlled to be 0 or minute includes, for example, a case where a motor in an idling state is started without applying a brake (windmill start), a case where the motor is rotated at a very low speed, and the like.

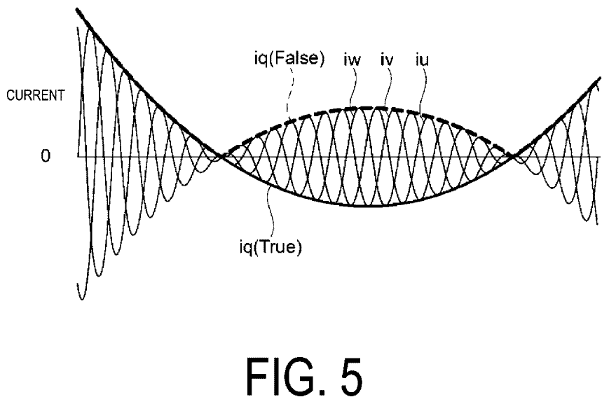

FIG. 5 is a diagram illustrating a relationship between the phase currents iu, iv, and iw of the respective phases of the motor 3 and the q-axis current.

In FIG. 5, a horizontal axis represents time and a vertical axis represents current.

As illustrated in FIG. 5, when the motor 3 is driven by a sine wave, the phase currents iu, iv, and iw of the coils of the respective phases of the motor 3 have, for example, sinusoidal waveforms with phases shifted from each other by 120°.

As described above, in order to maximize the efficiency of the motor, the d-axis current id is set to 0. When the d-axis current id is 0, as illustrated in FIG. 5, the q-axis current iq substantially matches the amplitudes of the phase currents iu, iv, and iw of the coils Lu, Lv, and Lw of the respective phases of the motor 3.

When the rotor 31 is rotating in the forward direction, the q-axis current is positive. In this case, as illustrated in FIG. 5, the q-axis current substantially matches the positive-side amplitudes of the phase currents iu, iv, and iw of the coils Lu, Lv, and Lw of the respective phases of the motor 3. On the other hand, when the rotor 31 is rotated in the reverse direction, the q-axis current is negative. In this case, as illustrated in FIG. 5, the q-axis current substantially matches not the positive-side amplitudes but the negative-side amplitudes of the phase currents iu, iv, and iw of the coils Lu, Lv, and Lw of the respective phases of the motor 3.

In this regard, the motor drive control device 10 according to the first embodiment estimates the q-axis current when the d-axis current id is 0, on the basis of the phase currents iu, iv, and iw flowing through the coils Lu, Lv, and Lw of the respective phases and phase currents −iu, −iv, and −iw obtained by inverting the polarities of the phase currents iu, iv, and iw (multiplying the phase currents iu, iv, and iw by −1).

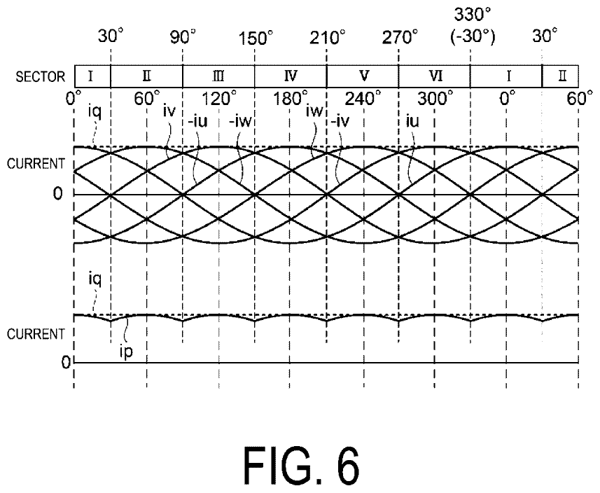

FIG. 6 is a diagram illustrating an example of a positive q-axis current and phase currents.

The upper part of FIG. 6 illustrates “sectors”, and the sectors are ranges obtained by dividing the range of an electrical angle from 0° to 360° into a plurality of sub-ranges. The middle part of FIG. 6 illustrates the phase currents iu, iv, and iw of the respective phases and the phase currents −iu, −iv, and −iw obtained by inverting the phases of the phase currents iu, iv, and iw of the respective phases by 180° (multiplying by −1). The lower part of FIG. 6 illustrates the positive q-axis current iq and an envelope curve indicating a temporal change of the peak value ip when a phase current closest to the q-axis current when the d-axis current is set to 0 among the phase currents flowing through the coils Lu, Lv, and Lw of the plurality of phases is set to the peak value ip. In FIG. 6, a horizontal axis represents an electrical angle and a vertical axis represents current.

As illustrated in FIG. 6, when the three-phase phase currents iu, iv, and iw and the phase currents −iu, −iv, and −iw obtained by inverting the polarities of the phase currents iu, iv, and iw are superimposed, the phase current closest to the q-axis current when the d-axis current is set to 0 is switched every electrical angle of 60°.

For example, as illustrated in FIG. 6, when the electrical angle X is in a range of −30°<X≤30°, the phase current iu is closest to the q-axis current iq. When the electrical angle X is in a range of 30°<X≤90°, the phase current −iw is closest to the q-axis current iq. When the electrical angle X is in a range of 90°<X≤150°, the phase current iv is closest to the q-axis current iq. When the electrical angle X is in a range of 150°<X≤210°, the phase current −iu is closest to the q-axis current iq. When the electrical angle X is in a range of 210° <X≤270°, the phase current iw is closest to the q-axis current iq. When the electrical angle X is in a range of 270°<X≤330°, the phase current −iv is closest to the q-axis current iq.

In this way, one of the phase currents iu, iv, iw, −iu, −iv, and −iw is closest to the q-axis current (positive) when the d-axis current is 0.

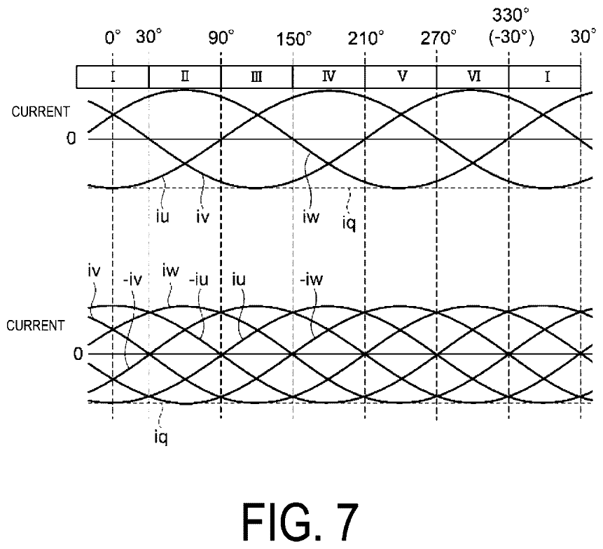

FIG. 7 is a diagram illustrating an example of a negative q-axis current and phase currents.

The upper part of FIG. 7 illustrates “sectors”, and the sectors are ranges obtained by dividing the range of the electrical angle from 0° to 360° into a plurality of sub-ranges. The middle part of FIG. 7 illustrates the phase currents iu, iv, and iw. The lower part of FIG. 7 illustrates the phase currents iu, iv, and iw, the phase currents −iu, −iv, and −iw obtained by inverting the polarities of the phase currents, and the q-axis current iq. In FIG. 7, a horizontal axis represents an electrical angle and a vertical axis represents current.

As described above, the phase of the current vector i when the q-axis current is negative is inverted by 180° with respect to the phase of the current vector i when the q-axis current is positive. Similarly, as illustrated in FIG. 7, the phase of each phase current when the q-axis current is negative is inverted by 180° with respect to the phase of each phase current when the q-axis current is positive. Therefore, as illustrated in FIG. 7, in each of sectors I to VI, the phase current serving as a candidate for the negative q-axis current is the same as the phase current serving as a candidate for the positive q-axis current.

For example, as illustrated in FIG. 7, when the electrical angle X is in a range of −30° <X≤30°, the phase current iu is closest to the q-axis current iq. When the electrical angle X is in a range of 30°<X≤90°, the phase current −iw is closest to the q-axis current iq. When the electrical angle X is in a range of 90°<X≤150°, the phase current iv is closest to the q-axis current iq. When the electrical angle X is in a range of 150°<X≤210°, the phase current −iu is closest to the q-axis current iq. When the electrical angle X is in a range of 210° <X≤270°, the phase current iw is closest to the q-axis current iq. When the electrical angle X is in a range of 270°<X≤330°, the phase current −iv is closest to the q-axis current iq.

Similarly, when the q-axis current is negative, one of the phase currents iu, iv, iw, −iu, −iv, and −iw is closest to the q-axis current (negative) when the d-axis current is 0.

In this regard, the q-axis current calculation unit 12 according to the first embodiment detects, as the peak value ip, a phase current closest to the q-axis current when the d-axis current is set to 0 among the phase currents iu, iv, and iw flowing through the coils Lu, Lv, and Lw of the respective phases and the phase currents −iu, −iv, and −iw obtained by inverting the phases of the phase currents iu, iv, and iw by 180°, on the basis of the current detection signal Vm and the rotation angle of the rotor 31 of the motor 3, and calculates the q-axis current of the two-phase rotating coordinate system when the d-axis current of the two-phase rotating coordinate system is set to 0, on the basis of the envelope of the peak value ip.

For example, as illustrated in FIG. 2, the q-axis current calculation unit 12 may include a peak value detection unit 121, a low-pass filter (LPF) 122, and a multiplication unit 123.

Some or all of the peak value detection unit 121, the low-pass filter 122, and the multiplication unit 123 may be implemented by program processing by the program processing device serving as the control circuit 1, or may be implemented by a dedicated hardware circuit.

On the basis of the current detection signal Vm and the rotation angle of the rotor 31 of the motor 3, the peak value detection unit 121 detects, as the peak value ip, the phase current closest to the q-axis current when the d-axis current is set to 0 among the phase currents iu, iv, iw, −iu, −iv, and −iw.

As described above, the phase current serving as a candidate for the q-axis current, that is, the phase current closest to the q-axis current when the d-axis current is set to 0, is switched every electrical angle of 60° (see FIGS. 6 and 7). In this regard, in the first embodiment, the range (0° to 360°) of the electrical angle according to the rotation of the rotor 31 is divided into a plurality of sub-ranges, each divided sub-range is set as a “sector”, and a phase current serving as a candidate for the peak value ip (q-axis current) is associated with each sector in advance.

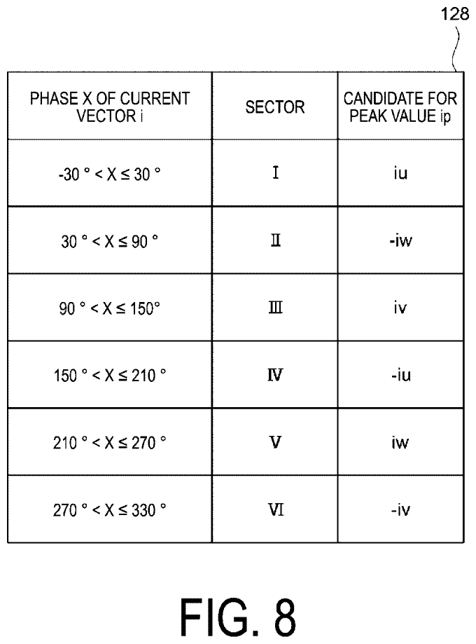

FIG. 8 is a diagram showing a correspondence relationship between sectors and phase currents serving as candidates for the peak value ip.

In each sector, one of the phase currents iu, iv, iw, −iu, −iv, and −iw is associated as a phase current serving as a candidate for the peak value ip. For example, as illustrated in FIGS. 6, 7, and 8, a range with the electrical angle X of −30°<X≤30° is set as the sector I, and the phase current iu closest to the q-axis current in the sector I is set as a candidate for the peak value ip in the sector I. A range with the electrical angle X of 30°<X≤90° is set as the sector II, and the phase current −iw closest to the q-axis current in the sector II is set as a candidate for the peak value ip in the sector II. A range with the electrical angle X of 90°<X≤150° is set as the sector III, and the phase current iv closest to the q-axis current iv the sector III is set as a candidate for the peak value ip in the sector III. A range with the electrical angle X of 150°<X≤210° is set as the sector IV, and the phase current −iu closest to the q-axis current in the sector IV is set as a candidate for the peak value ip in the sector IV. A range with the electrical angle X of 210°<X≤270° is set as the sector V, and the phase current iw closest to the q-axis current in the sector V is set as a candidate for the peak value ip in the sector V. A range with the electrical angle X of 270°<X≤330° is set as the sector VI, and the phase current −iv closest to the q-axis current in the sector VI is set as a candidate for the peak value ip in the sector VI.

The peak value detection unit 121 detects the phase of the current vector i in the two-phase (d, q) rotating coordinate system on the basis of the rotation angle of the rotor 31 and the current detection signal Vm, specifies a sector including the phase of the current vector i, and outputs a phase current associated with the specified sector as the peak value ip. The peak value detection unit 121 includes, for example, a current phase detection unit 124, a sector specifying unit 125, a phase current calculation unit 126, and a phase current selection unit 127 as functional blocks for implementing the above processing.

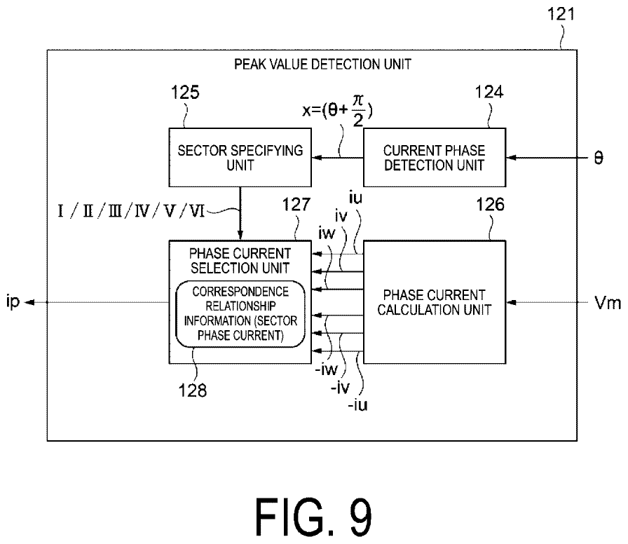

FIG. 9 is a diagram illustrating a configuration example of the peak value detection unit 121 according to the first embodiment.

The current phase detection unit 124 detects the phase of the current vector i in the two-phase rotating coordinate system. For example, the current phase detection unit 124 detects the phase of the current vector i on the basis of the rotation angle θ of the rotor 31.

As illustrated in FIG. 3, the q-axis direction is shifted by +90° (π/2) with respect to the rotation angle θ (d-axis direction=N-pole direction) of the rotor 31. When the d-axis current is 0, the current vector i matches the q-axis current.

In this regard, the current phase detection unit 124 calculates, as the phase of the current vector i, a rotation angle (θ+π/2) obtained by adding “π/2” to the rotation angle θ of the rotor 31 acquired by the rotation angle acquisition unit 14 to be described below. For example, the current phase detection unit 124 calculates the phase of the current vector i for each control cycle (PWM cycle) of the motor.

The phase current calculation unit 126 calculates a phase current on the basis of the current detection signal Vm.

For example, in the case of the above-described 1-shunt method of detecting the current of the motor 3 by connecting one shunt resistor in series to the inverter circuit, a path of a current is changed in accordance with the driving transistors Q1 to Q6 turned on in the control cycle (PWM cycle) of the motor, and the phase current indicated by the current detection signal Vm is switched by switching of the path.

In this regard, the phase current calculation unit 126 calculates the phase currents iu, iv, and iw from the current detection signal Vm in accordance with the ON/OFF timing of the drive transistors Q1 to Q6 of the inverter circuit in each control cycle of the motor 3 by, for example, a known current detection method of the 1-shunt method. Moreover, the phase current calculation unit 126 calculates the phase currents −iu, −iv, and −iw by multiplying the phase currents iu, iv, and iw by “−1”.

The sector specifying unit 125 specifies a sector including the phase of the current vector i in the two-phase rotating coordinate system detected by the current phase detection unit 124. For example, as illustrated in FIGS. 6 and 7, when the range of the electrical angle from 0 to 360° is divided into six sectors I to VI, the sector specifying unit 125 specifies the sector I, II, III, IV, V, or VI including the phase of the current vector i. For example, the sector specifying unit 125 specifies a sector including the phase (θ+π/2) of the current vector i for each control cycle of the motor 3, and outputs information on the specified sector.

The phase current selection unit 127 selects one phase current from a plurality of phase currents on the basis of the information on the sector including the phase of the current vector i, and outputs the selected phase current as the peak value ip. The phase current selection unit 127 selects a phase current serving as a candidate for the peak value ip (q-axis current) by using, for example, correspondence relationship information 128 shown in FIG. 8 and indicating a correspondence relationship between sectors and phase currents serving as candidates for the peak value ip.

As shown in FIG. 8, the correspondence relationship information 128 is, for example, a table including sectors associated with phase currents serving as candidates for the peak value ip. The correspondence relationship information 128 is stored in advance at, for example, a storage device (for example, a nonvolatile storage device) of the control circuit 1. For example, after the motor drive control device 10 is activated, the phase current selection unit 127 reads the correspondence relationship information 128 from the above storage device.

The phase current selection unit 127 uses, as an argument, the sector including the phase of the current vector i specified by the sector specifying unit 125, and reads a phase current corresponding to the argument from the correspondence relationship information 128. The phase current selection unit 127 outputs the read phase current as the peak value ip.

For example, in the case of the correspondence relationship information 128 shown in FIG. 8, when the sector including the phase of the current vector i is the “sector II”, the phase current selection unit 127 selects the phase current −iw and outputs the phase current −iw as the peak value ip. The phase current selection unit 127 outputs the peak value ip for each control cycle of the motor. Thus, the envelope of the peak value ip having a magnitude changed over time is output from the phase current selection unit 127.

The envelope of the peak value ip (hereinafter, also referred to as a “signal of the peak value ip”) changes in magnitude (vibrates) on the basis of the amplitude of a three-phase alternating current. In this regard, a high-frequency component included in the signal of the peak value ip is removed by the low-pass filter 122.

The low-pass filter 122 receives the peak value ip (the signal of the peak value ip) output from the peak value detection unit 121 (the phase current selection unit 127). The low-pass filter 122 removes a high-frequency component from the input signal of the peak value ip and outputs a signal obtained by smoothing the signal of the peak value ip (hereinafter, also referred to as an “average value of the peak value ip”).

The average value of the peak value ip output from the low-pass filter 122 is a value smaller than the q-axis current. In this regard, the multiplication unit 123 multiplies the signal (the average value of the peak value ip) output from the low-pass filter 122 by a predetermined value. For example, the average value of the peak value ip is a value 3/π times smaller than the q-axis current. In this regard, the multiplication unit 123 multiplies the value output from the low-pass filter 122 by “π/3”, for example. Thus, an approximate value (estimated value) of the q-axis current when the d-axis current id is 0 can be obtained. The multiplication unit 123 outputs the approximate value of the q-axis current calculated as described above as the “q-axis current iq”.

The above predetermined value is not limited to “π/3” described above, and may be set as appropriate so that an appropriate approximate value of the q-axis current can be calculated from the value output from the low-pass filter 122.

The computation unit 13 is described below.

The computation unit 13 generates the drive control signal Sd by performing a vector control computation by using the q-axis current iq calculated by the q-axis current calculation unit 12, the drive command signal Sc (speed command signal Sc1) acquired by the drive command acquisition unit 11, the rotation speed ω of the rotor 31 of the motor 3, and the rotation angle θ of the rotor 31.

For example, as illustrated in FIG. 2, the computation unit 13 includes the rotation angle acquisition unit 14, a rotation speed acquisition unit 15, error calculation units 16 and 18, a q-axis current command value calculation unit 17, a voltage command value calculation unit 19, a lead angle control unit 20, an addition unit 21, and a drive control signal generation unit 22.

The rotation angle acquisition unit 14 is a functional unit acquiring a measurement value of the rotation angle of the rotor 31 of the motor 3. The rotation angle acquisition unit 14 calculates the rotation angle (rotation position) θ of the rotor 31 of the motor 3 by a known calculation method on the basis of the rotation position detection signals Hu, Hv, and Hw output from the position sensors 4u, 4v, and 4w, for example.

The rotation speed acquisition unit 15 is a functional unit acquiring a measured value of the rotation speed of the rotor 31 of the motor 3. The rotation speed acquisition unit 15 calculates the rotation speed ω of the rotor 31 of the motor 3 by a known calculation method on the basis of the rotation position detection signals Hu, Hv, and Hw output from the position sensors 4u, 4v, and 4w. In the embodiment, for example, the rotation speed acquisition unit 15 calculates the rotation speed ω of the rotor 31 of the motor 3 on the basis of the rotation angle θ calculated by the rotation angle acquisition unit 14.

The error calculation unit 16 is a functional unit calculating a difference (ωref−ω) between the target rotation speed ωref output from the drive command acquisition unit 11 and the actual rotation speed ω of the motor 3 acquired by the rotation speed acquisition unit 15.

The q-axis current command value calculation unit 17 is a functional unit calculating a command value ωref of the q-axis current to reduce the difference between the target rotation speed ωref and the rotation speed ω of the motor 3. For example, the q-axis current command value calculation unit 17 calculates, by a PI control computation, the command value iqref of the q-axis current as a control amount of the motor 3 so that the error (ωref−ω) calculated by the error calculation unit 16 is 0.

The error calculation unit 18 is a functional unit calculating the difference (iqref−iq) between the command value iqref of the q-axis current calculated by the q-axis current command value calculation unit 17 and the q-axis current iq calculated by the q-axis current calculation unit 12.

The voltage command value calculation unit 19 is a functional unit calculating a voltage command value vref of the two-phase (d, q) rotating coordinate system to reduce the difference between the command value iqref of the q-axis current calculated by the q-axis current command value calculation unit 17 and the q-axis current iq calculated by the q-axis current calculation unit 12. For example, the voltage command value calculation unit 19 calculates, by a PI control computation, the voltage command value vref as the control amount of the motor 3 so that the error (iqref−iq) calculated by the error calculation unit 18 is 0.

The lead angle control unit 20 is a functional unit controlling the lead angle of the motor 3.

The lead angle control unit 20 calculates a phase lead angle (lead angle value Y) of a voltage applied to each of the coils Lu, Lv, and Lw (phase applied voltage), on the basis of the q-axis current iq calculated by the q-axis current calculation unit 12 and the rotation speed ω of the rotor 31 acquired by the rotation speed acquisition unit 15. Specifically, the lead angle control unit 20 calculates a lead angle value δ allowing the d-axis current Id of the two-phase (d, q) rotating coordinate system to be 0. A method of calculating the lead angle value δ is described below in detail.

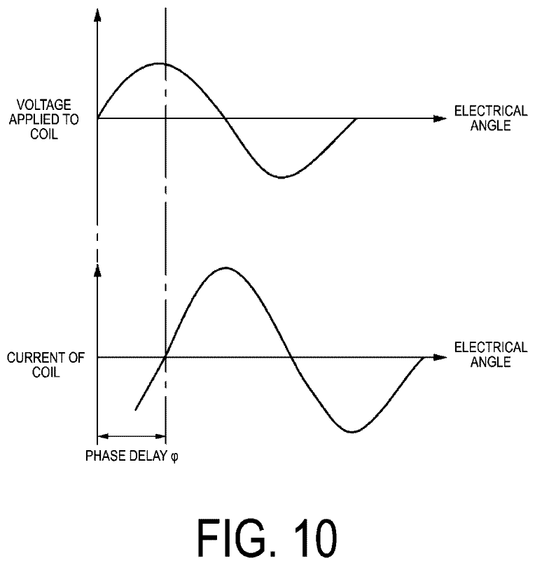

FIG. 10 is a diagram for explaining a current delay with respect to a voltage applied to a coil of a motor.

In general, when a voltage is applied to a coil of a motor, a phase of a current of the coil is delayed with respect to the applied voltage due to the inductance of the coil. In this regard, in general lead angle control, the phase of the applied voltage is advanced by a phase delay φ of the current of the coil with respect to the applied voltage to perform control so that the current is in a desired phase. The lead angle of the phase of the applied voltage in the case is referred to as the lead angle value φ.

As described above, in the surface permanent magnet synchronous motor (SPMSM), since the d-axis inductance and the q-axis inductance are equal to each other, the motor efficiency is maximized when the d-axis current id is 0. The phase of the applied voltage may be advanced by the lead angle value φ with respect to the q-axis so that the d-axis current id is 0, that is, the current includes only a q-axis component.

In this regard, the motor drive control device 10 according to the first embodiment calculates the lead angle value φ allowing the d-axis current id of the rotating coordinate system to be 0, and performs a space vector conversion on the basis of information on polar coordinates represented by the lead angle value φ and the voltage command value vref of the rotating coordinate system to generate the drive control signal Sd.

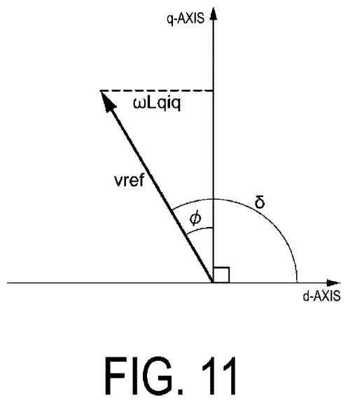

FIG. 11 is a diagram for explaining a method of calculating the lead angle value.

FIG. 11 illustrates the voltage command value vref (vector) when a horizontal axis is a d-axis and a vertical axis is a q-axis.

In general, a d-axis voltage value vd of the permanent magnet synchronous motor (PMSM) in the two-phase (d, q) rotating coordinate system is represented by Equation (2) below.

$$\begin{matrix}[ Mathematical Expression 2 ] & \\ {v}_{d} = {Ri}_{d} + {L}_{d} \frac{d}{d x} {i}_{d} - ω {L}_{q} {i}_{q} & ( 2 )\end{matrix}$$

In Equation (2) above, the d-axis voltage value vd obtained when the d-axis current id is 0 can be represented by Equation (3) below from Equation (2) above.

$$\begin{matrix}[ Mathematical Expression 3 ] & \\ {v}_{d} = - ω {L}_{q} {i}_{q} & ( 3 )\end{matrix}$$

Accordingly, by performing lead angle control for determining the lead angle value φ so that a d-axis direction component of the vector of the voltage command value vref is “−ωLqiq”, the driving of the motor 3 can be controlled so that the d-axis current id is 0.

As illustrated in FIG. 11, when an angle between the vector of the voltage command value vref and the q-axis is φ, Equation (4) below is established from Equation (3) above.

$$\begin{matrix}[ Mathematical Expression 4 ] & \\ {v}_{ref} sin ϕ = - {v}_{d} = ω {L}_{q} {i}_{q} & ( 4 )\end{matrix}$$

From Equation (4) above, the lead angle value φ obtained when the d-axis current id is 0 is represented by Equation (5) below.

$$\begin{matrix}[ Mathematical Expression 5 ] & \\ ϕ = {sin}^{- 1} \frac{ω {L}_{q} {i}_{q}}{{v}_{ref}} & ( 5 )\end{matrix}$$

In the motor drive control device 10 according to the present embodiment, the lead angle control unit 20 calculates the lead angle value φ allowing the d-axis current id of the two-phase (d, q) rotating coordinate system to be 0 on the basis of the q-axis current iq calculated by the q-axis current calculation unit 12 and the rotation speed ω of the rotor 31 acquired by the rotation speed acquisition unit 15.

Specifically, the lead angle control unit 20 calculates an angle (lead angle value) φ of the vector of the voltage command value vref with respect to the q-axis when a component of the vector of the voltage command value vref in the d-axis direction matches the d-axis voltage value vd when the d-axis current id is 0.

The rotation angle θ of the rotor 31 of the motor 3 is a rotation angle with respect to the d-axis. On the other hand, as illustrated in FIG. 11, the lead angle value φ is an angle of the vector of the voltage command value vref with respect to the q-axis. Accordingly, the lead angle value δ based on the d-axis is “φ+π/2”. The lead angle control unit 20 calculates and outputs the lead angle value δ (=φ+π/2).

Specifically, the lead angle control unit 20 calculates the lead angle value δ by using correspondence relationship information 201 indicating a correspondence relationship among the rotation speed ω of the rotor 31, the q-axis current iq, and the lead angle value δ (φ). The following methods are examples of methods of calculating the lead angle value δ by using the correspondence relationship information 201.

In a first method, the lead angle control unit 20 may include, as the correspondence relationship information 201, a function of the lead angle value φ represented by Equation (5) above, and calculate the lead angle value φ on the basis of Equation (5) above. For example, the function of the angle φ represented by Equation (5) above is stored in advance at the memory of the control circuit 1 as the correspondence relationship information 201. The lead angle control unit 20 reads Equation (5) above as the correspondence relationship information 201 from the memory, and substitutes the q-axis current iq calculated by the q-axis current calculation unit 12 and the rotation speed ω of the rotor 31 acquired by the rotation speed acquisition unit 15 into Equation (5) above to calculate the angle φ allowing the d-axis current id to be 0. Subsequently, the lead angle control unit 20 outputs a value obtained by adding π/2 to the calculated angle φ, as the lead angle value δ based on the d-axis.

In Equation (5) above, the q-axis inductance Lq is a fixed value. Accordingly, the lead angle control unit 20 can use, for example, a value stored in advance at the memory of the control circuit 1 as the q-axis inductance Lq in the computation using Equation (5) above. In addition, the lead angle control unit 20 can use the value calculated by the voltage command value calculation unit 19 as the voltage command value vref in the computation using Equation (5) above.

Note that since the voltage command value vref can be calculated from the q-axis current iq and the rotation speed ω, the lead angle control unit 20 may calculate the value of the voltage command value vref by using the q-axis current iq and the rotation speed ω without acquiring the value of the voltage command value vref from the voltage command value calculation unit 19.

In a second method, the lead angle control unit 20 may include, as the correspondence relationship information 201, a table having the lead angle value δ associated with each of combinations of the rotation speed ω and the q-axis current iq, and calculate the lead angle value φ on the basis of the table.

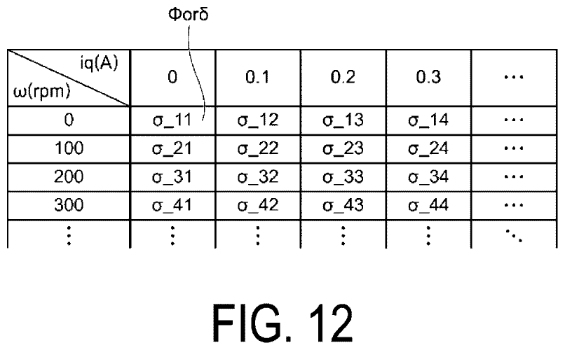

FIG. 12 is a diagram showing an example of a table serving as the correspondence relationship information 201 with the lead angle value δ associated with each of combinations of the rotation speed ω and the q-axis current iq.

As described above, the q-axis inductance Lq is a fixed value, and the voltage command value vref can be calculated from the q-axis current iq and the rotation speed ω. In this regard, an optimum lead angle value δ is actually measured in advance with the rotation speed ω of the rotor 31 and the q-axis current iq as variables. Alternatively, the lead angle value δ is calculated in advance using Equation (5) above. Subsequently, a table having the lead angle value δ associated with each of the combinations of the rotation speed ω and the q-axis current iq as variables is prepared, and is stored in advance at the memory of the control circuit 1 as the correspondence relationship information 201.

The lead angle control unit 20 uses, as arguments, the q-axis current iq calculated by the q-axis current calculation unit 12 and the rotation speed ω of the rotor 31 acquired by the rotation speed acquisition unit 15, refers to the table serving as the correspondence relationship information 201, reads the lead angle value δ corresponding to the arguments from the table, and outputs the read lead angle value δ.

The lead angle value δ calculated by the above-described methods is input to the addition unit 21. The addition unit 21 adds the lead angle value δ output from the lead angle control unit 20 and the rotation angle θ of the rotor 31 acquired by the rotation angle acquisition unit 14, and outputs the added value as information on an angle σ (=θ+δ) of the vector (voltage vector v) of the voltage command value vref.

The drive control signal generation unit 22 is a functional unit generating the drive control signal Sd on the basis of the voltage command value vref and the angle σ obtained by adding the lead angle value δ and the rotation angle θ of the rotor 31. The drive control signal generation unit 22 performs a space vector conversion on the basis of, for example, information on polar coordinates represented by the voltage command value vref output from the voltage command value calculation unit 19 and the angle σ (=θ+δ) output from the addition unit 21. That is, the drive control signal generation unit 22 converts a voltage vector v represented by the voltage command value vref and a polar coordinate value of the angle σ (=θ+δ) into a voltage signal (PWM signal) of a three-phase (U, V, W) fixed coordinate system by using a known space vector conversion computation method, and outputs the converted signal as the drive control signal Sd.

The flow of a process for generating the drive control signal Sd by the motor drive control device 10 according to the first embodiment is described below.

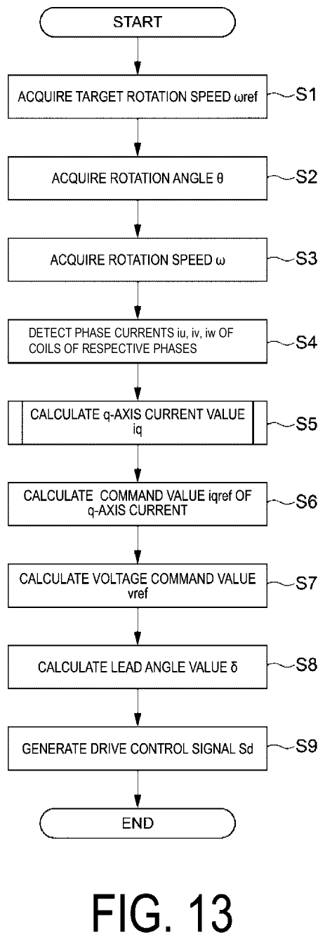

FIG. 13 is a flowchart illustrating an example of the flow of the process for generating the drive control signal Sd by the motor drive control device 10 according to the first embodiment.

First, when the speed command signal Sc1 is input from a host device, for example, the control circuit 1 analyzes the speed command signal Sc1 to acquire information on the target rotation speed ωref of the motor 3 specified by the speed command signal Sc1 (step S1).

Subsequently, the control circuit 1 acquires the rotation angle θ of the rotor 31 of the motor 3 (step S2). Specifically, as described above, the rotation angle acquisition unit 14 calculates the rotation angle θ of the rotor 31 of the motor 3 on the basis of the rotation position detection signals Hu, Hv, and Hw output from the Hall elements 4u, 4v, and 4w serving as the position sensors.

The control circuit 1 acquires the rotation speed ω of the motor 3 (step S3). Specifically, as described above, the rotation speed acquisition unit 15 calculates the rotation speed ω of the rotor 31 of the motor 3 on the basis of the rotation angle θ of the rotor 31 calculated in step S2.

The control circuit 1 detects the phase currents iu, iv, and iw of the coils of the respective phases of the motor 3 (step S4). Specifically, the current detection circuit 2c outputs the current detection signal Vm corresponding to the respective phase currents iu, iv, and iw of the coils by the above-described method, and the q-axis current calculation unit 12 acquires the current detection signal Vm.

Subsequently, the control circuit 1 calculates the q-axis current iq (step S5).

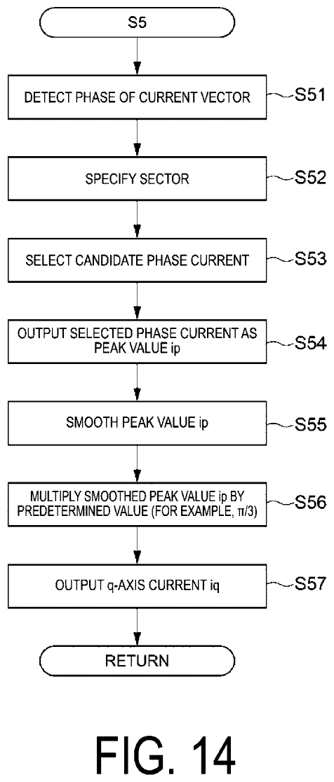

FIG. 14 is a flowchart illustrating an example of the flow of the process (step S5) of calculating the q-axis current iq according to the first embodiment.

In step S5, first, the current phase detection unit 124 detects the phase of the current vector i on the basis of the rotation angle θ of the rotor 31 (step S51). As described above, the current phase detection unit 124 calculates, as the phase of the current vector i, the rotation angle (θ+π/2) obtained by adding “π/2” to the rotation angle θ of the rotor 31 acquired by the rotation angle acquisition unit 14.

Subsequently, the sector specifying unit 125 specifies a sector including the phase (θ+π/2) of the current vector i (step S52). The sector specifying unit 125 specifies the sector I, II, III, IV, V, or VI including the phase of the current vector i among the six sectors I to VI illustrated in FIGS. 6 and 7.

Subsequently, the phase current selection unit 127 selects one phase current serving as a candidate for the peak current value ip from the plurality of phase currents (step S53). Specifically, as described above, the phase current selection unit 127 uses, as an argument, the sector including the phase of the current vector i specified in step S52, and reads the candidate phase current from the correspondence relationship information 128.

Subsequently, the phase current selection unit 127 outputs the candidate phase current selected in step S53 as the peak value ip (step S54). Specifically, the phase current selection unit 127 outputs, as the peak value ip, a candidate phase current among the plurality of phase currents output from the phase current calculation unit 126.

Subsequently, the low-pass filter 122 smooths the signal (envelope) of the peak value ip output from the phase current selection unit 127 (step S55). Subsequently, the multiplication unit 123 multiplies the signal smoothed by the low-pass filter 122 (the average value of the peak value ip) by a predetermined value (step S56). Specifically, as described above, the multiplication unit 123 multiplies the average value of the peak value ip output from the low-pass filter 122 by “π/3”. Subsequently, the multiplication unit 123 outputs, as the q-axis current iq, a value obtained by multiplying the average value of the peak value ip by the predetermined value (step S57).

In FIG. 13, after completion of the process of step S5 or in parallel with step S5, the control circuit 1 calculates the command value iqref of the q-axis current (step S6).

Specifically, as described above, the error calculation unit 16 calculates the difference between the target rotation speed ωref and the actual rotation speed ω of the motor 3, and the q-axis current command value calculation unit 17 performs a PI control computation so that the difference calculated by the error calculation unit 16 is 0 and calculates the command value iqref of the q-axis current.

Subsequently, the control circuit 1 calculates the voltage command value vref of the two-phase (d, q) rotating coordinate system to reduce the difference between the command value iqref of the q-axis current calculated in step S6 and the q-axis current iq calculated in step S5 (step S7). Specifically, as described above, the error calculation unit 18 calculates the difference between the command value iqref of the q-axis current and the actual q-axis current iq of the motor 3, and the voltage command value calculation unit 19 performs a PI control computation so that the difference calculated by the error calculation unit 18 is 0 and calculates the voltage command value vref.

Subsequently, the control circuit 1 calculates the lead angle value δ allowing the d-axis current id to be 0, on the basis of the q-axis current iq calculated in step S5 and the rotation speed ω of the rotor 31 acquired in step S3 (step S8). Specifically, the lead angle control unit 20 calculates the lead angle value δ by the above-mentioned methods using the correspondence relationship information 201.

Subsequently, the control circuit 1 generates the drive control signal Sd on the basis of the angle σ obtained by adding the lead angle value δ calculated in step S8 and the rotation angle θ of the rotor 31, and the voltage command value vref calculated in step S7 (step S9). Specifically, as described above, the drive control signal generation unit 22 converts a voltage vector represented by the voltage command value vref and the polar coordinate value of the angle σ (=θ+δ) into a voltage signal (PWM signal) of the three-phase (U, V, W) fixed coordinate system by using a known space vector conversion computation method, and outputs the converted signal as the drive control signal Sd.

The drive control signal Sd generated by the processing procedure described above is supplied to the drive circuit 2. The drive circuit 2 controls the energization of the coil of the motor 3 by the method described above on the basis of the input drive control signal Sd. Thus, the motor 3 is controlled to rotate at the target rotation speed ωref specified by the speed command signal Sc1.

As described above, in the motor drive control device 10 according to the first embodiment, the control circuit 1 detects, as the peak value ip, one of the phase currents iu, iv, and iw flowing through the coils Lu, Lv, and Lw of the respective phases and the phase currents −iu, −iv, and −iw obtained by inverting the phases of the phase currents iu, iv, and iw by 180°, calculates the q-axis current when the d-axis current in the two-phase rotating coordinate system is set to 0, on the basis of the envelope of the peak value ip, and performs the vector control computation to generate the drive control signal Sd.

According to such a configuration, since no coordinate conversion in the related art needs to be performed in order to calculate the q-axis current, a computation load in motor drive control can be reduced. Thus, the processing capacity required for the program processing device such as a microcontroller serving as the control circuit 1 can be reduced, so that the motor drive control device 10 can be provided at a lower cost.

In addition, by detecting, as the peak value ip, a phase current closest to the q-axis current among the phase currents iu, iv, iw, −iu, −iv, and −iw, the q-axis current can be appropriately estimated even when the q-axis current is negative or when the q-axis current is 0 or a minute value. Thus, for example, control for reversely rotating the rotor 31 of the motor 3, control for starting the motor in an idling state without applying a brake (windmill start), control for rotating the motor at a very low speed, and the like, can be stably performed.

In addition, the control circuit 1 stores the correspondence relationship information 128 including sectors associated with phase currents serving as candidates for the peak value ip, the sectors being obtained by dividing the range of the electrical angle according to the rotation of the rotor 31 into a plurality of sub-ranges. The q-axis current calculation unit 12 detects the phase of the current vector i in the two-phase (d, q) rotating coordinate system on the basis of the rotation angle of the rotor 31 and the current detection signal Vm, and specifies a sector including the phase of the current vector i. The q-axis current calculation unit 12 selects a candidate phase current associated with the specified sector on the basis of the correspondence relationship information 128, and sets the selected phase current as the peak value ip.

As described above, since a phase current closest to the q-axis current is determined in accordance with the electrical angle, the correspondence relationship information 128 including each sector associated with a phase current serving as a candidate for the peak value ip (q-axis current) is prepared in advance and a candidate phase current associated with the sector including the phase of the current vector i is read from the correspondence relationship information 128, so that the phase current closest to the q-axis current can be easily determined. Thus, a computation load at the control circuit 1 can be further reduced.

As described above, the motor drive control device 10 according to the first embodiment can appropriately calculate the q-axis current while suppressing a computation load.

In addition, the control circuit 1 drives the motor 3 by performing lead angle control so that the d-axis current id is 0 in order to maximize the efficiency of the motor 3. According to such a configuration, a computation load can be reduced compared to the related art that calculates the d-axis current id by coordinate conversion and performs a vector control computation so that the calculated d-axis current id is 0. Thus, the processing capacity required for the program processing device serving as the control circuit 1 can be further reduced, so that the motor drive control device 10 can be provided at a lower cost.

In addition, the control circuit 1 uses the correspondence relationship information 201 indicating a correspondence relationship among the rotation speed ω of the rotor 31, the q-axis current iq, and the lead angle value δ when calculating the lead angle value δ (φ) allowing the d-axis current id to be 0. Thus, a computation load at the control circuit 1 can be further reduced. For example, as described above, a table including the lead angle value δ associated with each of the combinations of the rotation speed ω of the rotor 31 and the q-axis current iq is stored in advance at the memory of the control circuit 1 as the correspondence relationship information 201. According to such a configuration, the lead angle value δ can be calculated without performing complicated calculations, so that a computation load at the control circuit 1 can be further reduced.

### Second Embodiment

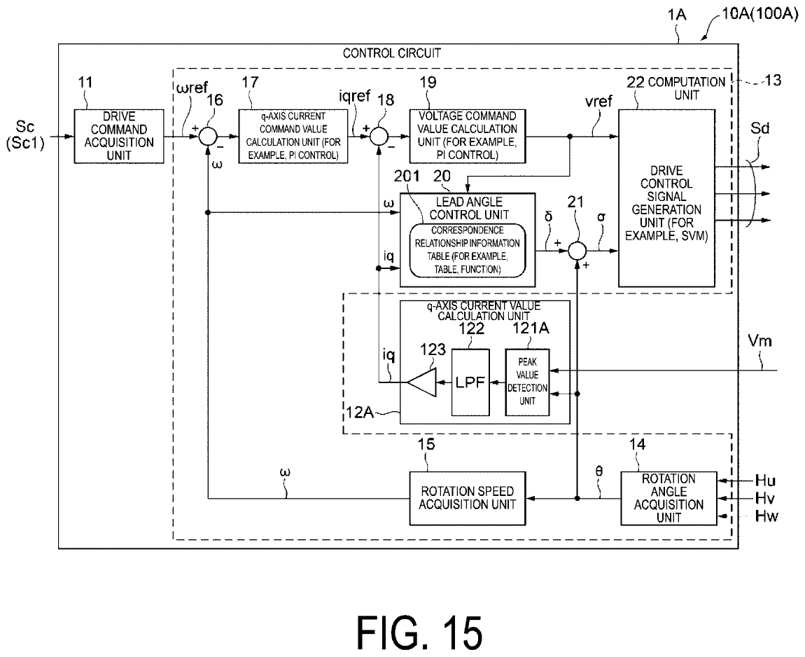

FIG. 15 is a diagram illustrating a functional block configuration of a control circuit 1A in a motor drive control device 10A according to a second embodiment.

Similarly to the motor drive control device 10 according to the first embodiment, the motor drive control device 10A constitutes a motor unit 100A together with the motor 3.

The control circuit 1A according to the second embodiment is different from the control circuit 1 according to the first embodiment in the method of detecting a peak value.

As described above, the phase of the current vector i can be calculated based on the rotation angle θ of the rotor 31 of the motor 3. However, the rotation position detection signals Hu, Hv, and Hw output from the Hall elements 4u, 4v, and 4w serving as the position sensors or the estimated value of the rotation angle of the rotor 31 calculated by the computation of the known position sensorless control may be shifted from the true value of the actual rotation angle of the rotor 31.

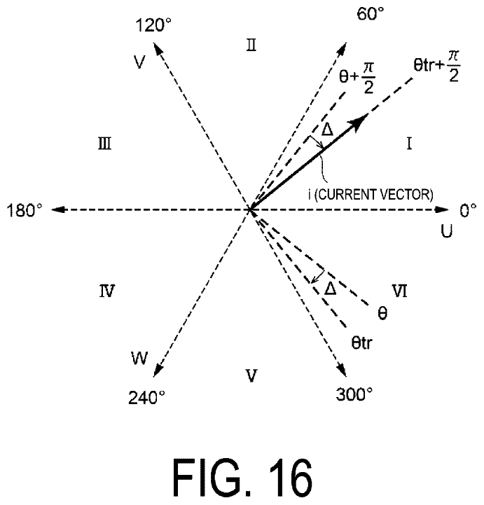

FIG. 16 is a diagram for explaining a shift of a current vector caused by a shift of an estimated value from the true value of the rotation angle of the rotor 31.

In FIG. 16, a true value of the rotation angle of the rotor 31 is represented by “θtr”, an estimated value of the rotation angle of the rotor 31 is represented by “θ”, and a shift of the estimated value from the true value of the rotation angle of the rotor 31 is represented by “Δ”.

As illustrated in FIG. 16, when the estimated value θ of the rotation angle of the rotor 31 is shifted from the true value θtr by “Δ”, the estimated value (θ+π/2) of the phase of the current vector i is also shifted from the true value (θtr+π/2) of the phase of the current vector i by “Δ”. As the shift (error) A increases, a candidate phase current based on the estimated value of the phase of the current vector i and a phase current closest to the q-axis current may be different from each other. In this regard, a peak value detection unit 121A according to the second embodiment sets a plurality of phase currents serving as candidates for the q-axis current for each sector.

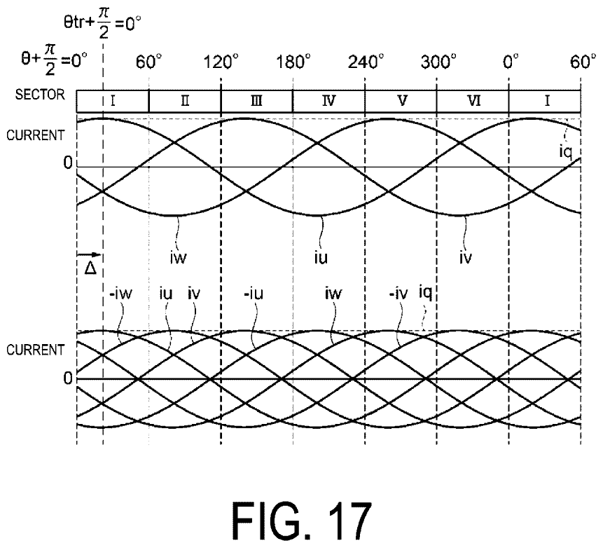

FIG. 17 is a diagram for explaining an overview of a method of estimating the q-axis current according to the second embodiment.

The upper part of FIG. 17 illustrates “sectors”, and the sectors are ranges obtained by dividing the range of an electrical angle from 0° to 360° into a plurality of sub-ranges. The middle part of FIG. 17 illustrates the phase currents iu, iv, and iw. The lower part of FIG. 17 illustrates the phase currents iu, iv, and iw, the phase currents −iu, −iv, and −iw obtained by inverting the polarities of the phase currents iu, iv, and iw, and the q-axis current iq. In FIG. 17, a horizontal axis represents an electrical angle and a vertical axis represents current.

In the second embodiment, the range of the electrical angle from 0° to 360° is divided into six sectors I to VI with reference to 0°. For example, as illustrated in FIG. 17, a range with the electrical angle X of 0°<X≤60° is set as the sector I, a range with the electrical angle X of 60°<X≤120° is set as the sector II, a range with the electrical angle X of 120°<X≤180° is set as the sector III, a range with the electrical angle X of 180°<X≤240° is set as the sector IV, a range with the electrical angle X of 240°<X≤300° is set as the sector V, and a range with the electrical angle X of 300°<X≤360° is set as the sector VI.

As illustrated in FIG. 17, the error Δ may occur between the estimated value (θ+π/2) of the phase of the current vector i and the true value (θtr+π/2) of the phase of the current vector i. The phase current closest to the q-axis current in each sector varies depending on the magnitude of the error Δ. For example, when the error Δ is in the range of −30°≤Δ≤+30°, two phase currents can be candidates for the peak value ip (q-axis current) in each sector. When the error Δ is in the range of −30°≤Δ≤+60°, three phase currents can be candidates for the peak value ip (q-axis current) in each sector.

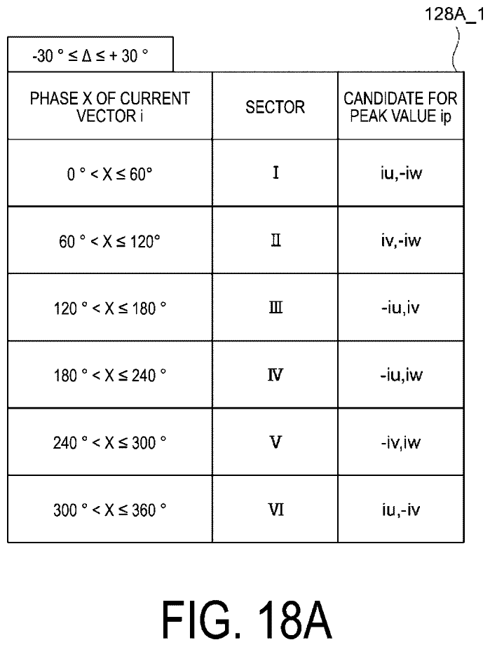

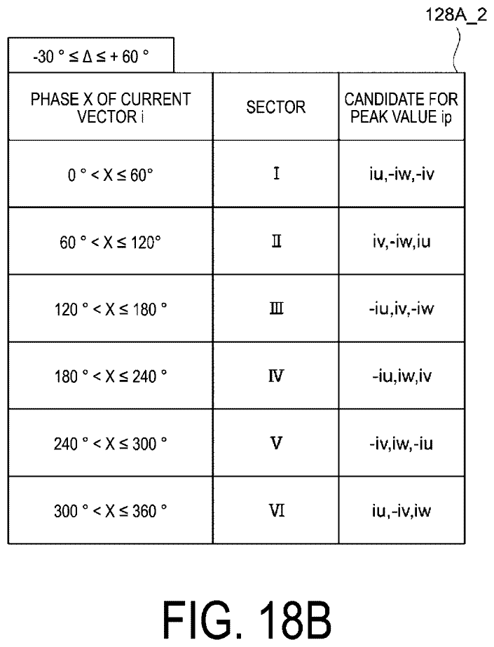

FIGS. 18A and 18B are diagrams showing an example of correspondence relationships between sectors and phase currents serving as candidates for the peak value ip in the second embodiment.

FIG. 18A shows correspondence relationship information 128A_1 between sectors and phase currents serving as candidates for the peak value ip when the error Δ is in the range of −30°≤Δ≤+30°. FIG. 18B shows correspondence relationship information 128A_2 between sectors and phase currents as candidates of the peak value ip in the case when the error Δ is in the range of −30°≤Δ≤+60°.

For example, when the error Δ is in the range of −30°≤Δ≤+30°, the phase current iu and the phase current −iw are candidates for the peak value ip in the sector I (0°<X≤60°) as shown in FIGS. 17 and 18A. In the sector II (60°<X≤120°), the phase current iv and the phase current −iw are candidates for the peak value ip. In the sector III (120°<X≤180°), the phase current −iu and the phase current iv are candidates for the peak value ip. In the sector IV (180°<X≤240°), the phase current −iu and the phase current iw are candidates for the peak value ip. In the sector V (240°<X≤300°), the phase current −iv and the phase current iw are candidates for the peak value ip. In the sector VI (300°<X≤360°), the phase current iu and the phase current −iv are candidates for the peak value ip.

For example, when the error Δ is in the range of −30°≤Δ≤+60°, the phase current iu, the phase current −iw, and the phase current −iv are candidates for the peak value ip in the sector I (0°<X≤60°) as shown in FIGS. 17 and 18B. In the sector II (60°<X≤120°), the phase current iv, the phase current −iw, and the phase current iu are candidates for the peak value ip. In the sector III (120°<X≤180°), the phase current −iu, the phase current iv, and the phase current −iw are candidates for the peak value ip. In the sector IV (180°<X≤240°), the phase current −iu, the phase current iw, and the phase current iv are candidates for the peak value ip. In the sector V (240°<X≤300°), the phase current −iv, the phase current iw, and the phase current −iu are candidates for the peak value ip. In the sector VI (300°<X≤360°), the phase current iu, the phase current −iv, and the phase current iw are candidates for the peak value ip.

In this way, since a plurality of phase currents are candidates for the peak value ip in consideration of the error Δ, the motor drive control device 10A according to the second embodiment associates the plurality of phase currents serving as candidates for the peak value with each sector. A q-axis current calculation unit 12A compares the absolute values of the magnitudes of the plurality of candidate phase currents with each other in each sector, and sets a phase current having the largest absolute value as the peak value.

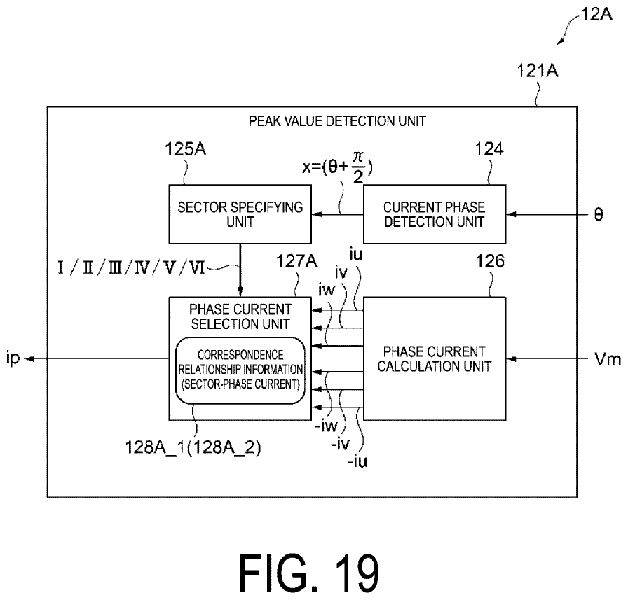

FIG. 19 is a diagram illustrating a configuration example of the peak value detection unit 121A according to the second embodiment.

A sector specifying unit 125A specifies a sector including the phase of the current vector i in the two-phase rotating coordinate system, the phase of the current vector i being detected by the current phase detection unit 124. For example, as illustrated in FIG. 17, when the range of the electrical angle from 0 to 360° is divided into six sectors I to VI, the sector specifying unit 125A specifies a sector including the phase (θ+π/2) of the current vector i, for example, for each control cycle of the motor 3, and outputs information on the specified sector.

In the motor drive control device 10A, at least one of the correspondence relationship information 128A_1 shown in FIG. 18A and the correspondence relationship information 128A_2 shown in FIG. 18B is stored in advance at a storage device (for example, a nonvolatile storage device) of the control circuit 1A.

For example, after the motor drive control device 10A is activated, a phase current selection unit 127A reads the correspondence relationship information 128A_1 or the correspondence relationship information 128A_2 from the above storage device. The phase current selection unit 127A refers to the correspondence relationship information 128A_1 or the correspondence relationship information 128A_2, and selects a candidate phase current associated with the sector including the phase of the current vector i specified by the sector specifying unit 125A.

Specifically, the phase current selection unit 127A uses, as an argument, the sector including the phase of the current vector i specified by the sector specifying unit 125A, selects a plurality of phase currents corresponding to the argument from the correspondence relationship information 128A_1 or the correspondence relationship information 128A_2, compares the absolute values of the plurality of selected phase currents with each other, and outputs a phase current having the largest absolute value as the peak value ip.

For example, in a case of storing the correspondence relationship information 128A_1 shown in FIG. 18A at the control circuit 1A, when the sector including the phase of the current vector i is the “sector II”, the phase current selection unit 127A selects the phase current iv and the phase current −iw, and compares the absolute value of the phase current iv with the absolute value of the phase current −iw. When the absolute value of the phase current iv is larger than the absolute value of the phase current −iw, the phase current selection unit 127A outputs the phase current iv as the peak value ip, and when the absolute value of the phase current −iw is larger than the absolute value of the phase current iv, the phase current selection unit 127A outputs the phase current −iw as the peak value ip.

For example, in a case of storing the correspondence relationship information 128A_2 shown in FIG. 18B at the control circuit 1A, when the sector including the phase of the current vector i is the “sector II”, the phase current selection unit 127A selects the phase current iv, the phase current −iw, and the phase current iu, and compares the absolute value of the phase current iv, the absolute value of the phase current −iw, and the absolute value of the phase current iu with one another. The phase current selection unit 127A selects a phase current having the largest absolute value and outputs the selected phase current as the peak value ip. For example, when the absolute value of the phase current iv is larger than the absolute value of the phase current −iw and the absolute value of the phase current iu, the phase current selection unit 127A outputs the phase current iv as the peak value ip.

Since the magnitude of the error Δ varies depending on the load of the motor 3, the range of the assumed rotation speed of the motor 3, and the like, at least one of the correspondence relationship information 128A_1 and the correspondence relationship information 128A_2 may be stored in advance at the control circuit 1A in consideration of an application actually adopting the motor unit 100A.

For example, when the error Δ is assumed to be relatively small, the correspondence relationship information 128A_1 may be stored at the storage device of the control circuit 1A, and when the error Δ is assumed to be relatively large, the correspondence relationship information 128A_2 may be stored at the storage device of the control circuit 1A. Alternatively, both the correspondence relationship information 128A_1 and 128A_2 may be stored at the storage device of the control circuit 1A, and the phase current selection unit 127A may read one of the correspondence relationship information from the storage device to detect the peak value ip.

In the second embodiment, the motor drive control device 10A drives the motor 3 in accordance with the flowchart illustrated in FIG. 13 as in the first embodiment. In the second embodiment, the process of step S5 is different from the process of step S5 (FIG. 14) according to the first embodiment. Hereinafter, the process (step S5) of calculating the q-axis current iq in the second embodiment is described below.

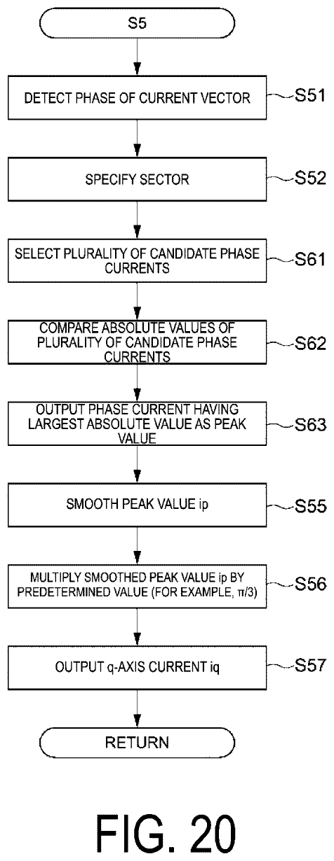

FIG. 20 is a flowchart illustrating an example of the flow of the process (step S5) of calculating the q-axis current iq in the second embodiment.

In step S5, first, the current phase detection unit 124 detects the phase of the current vector i on the basis of the rotation angle θ of the rotor 31 (step S51). For example, as described above, the current phase detection unit 124 calculates, as the phase of the current vector i, the rotation angle (θ+π/2) obtained by adding “π/2” to the rotation angle θ of the rotor 31 acquired by the rotation angle acquisition unit 14.

Subsequently, the sector specifying unit 125A specifies a sector including the phase of the current vector i (step S52). For example, the sector specifying unit 125A specifies the sector I, II, III, IV, V, or VI including the phase of the current vector i among the six sectors I to VI shown in FIG. 18.

Subsequently, the phase current selection unit 127A selects phase currents serving as candidates for the peak value ip from the plurality of phase currents (step S61). Specifically, as described above, the phase current selection unit 127A uses, as an argument, the sector including the phase of the current vector i specified in step S52, and reads a plurality of candidate phase currents from the correspondence relationship information 128A_1 or the correspondence relationship information 128A_2.

Subsequently, the phase current selection unit 127A compares the absolute values of the plurality of candidate phase currents selected in step S61 with each other by the above-described method (step S62). Subsequently, the phase current selection unit 127A selects a phase current having the largest absolute value among the plurality of candidate phase currents, and outputs the selected phase current as the peak value ip (step S63).

Processes after step S63 are the same as the processes according to the first embodiment. That is, the low-pass filter 122 smooths the signal of the peak value ip output from the phase current selection unit 127A (step S55). Subsequently, the multiplication unit 123 multiplies the peak value ip smoothed by the low-pass filter 122 by a predetermined value (π/3) (step S56). Subsequently, the multiplication unit 123 outputs a value obtained by multiplying the smoothed peak value ip by a predetermined value as the q-axis current iq (step S57).

As described above, the motor drive control device 10A according to the second embodiment can appropriately calculate the q-axis current while suppressing a computation load, similarly to the motor drive control device 10 according to the first embodiment.

Specifically, when a plurality of phase currents serving as candidates for a peak value are associated with the sectors I to VI, the q-axis current calculation unit 12A compares the absolute values of the plurality of candidate phase currents with each other, and sets a phase current having the largest absolute value as the peak value ip.

According to such a configuration, even when the error Δ occurs between the estimated value (θ+π/2) of the phase of the current vector i and the true value (θtr+π/2) of the phase of the current vector i, a phase current closest to the q-axis current can be selected for each sector, so that the q-axis current can be calculated with higher accuracy.

### Third Embodiment

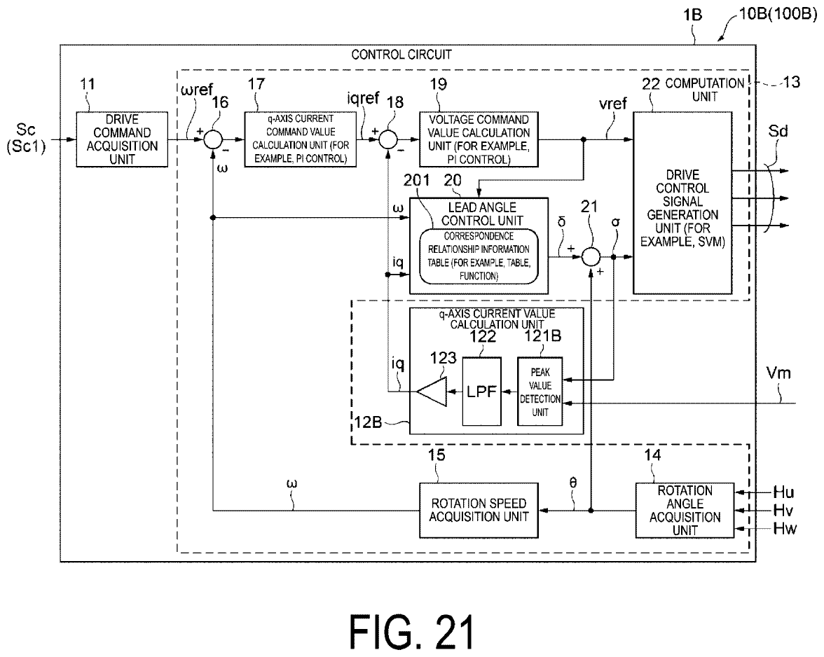

FIG. 21 is a diagram illustrating a functional block configuration of a control circuit 1B in a motor drive control device 10B according to a third embodiment.

Similarly to the motor drive control device 10 according to the first embodiment, the motor drive control device 10B constitutes a motor unit 100B together with the motor 3.

The control circuit 1B according to the third embodiment is different from the control circuits 1 and 1A according to the first and second embodiments in the method of detecting the phase of the current vector i. In the first and second embodiments, the phase of the current vector i is estimated based on the rotation angle of the rotor 31; however, in the third embodiment, the phase of the current vector i is estimated based on a phase of a voltage vector.

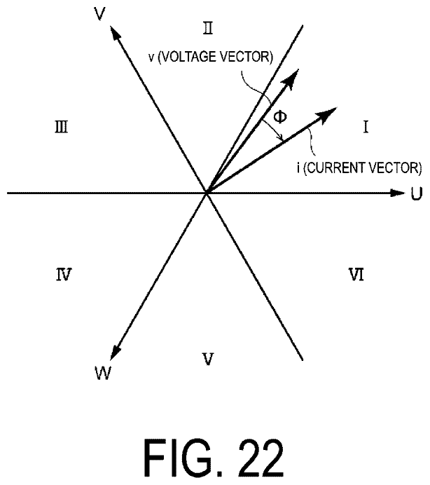

FIG. 22 is a diagram illustrating a relationship between the current vector i and the voltage vector v in the two-phase rotating coordinate system. In FIG. 22, the shift width of the phase of the current vector i with respect to the phase of the voltage vector v is represented by “φ”.

As illustrated in FIG. 22, in general, in motor drive control, the phase of the current vector i in the two-phase (d, q) rotating coordinate system is delayed with respect to the phase of the voltage vector. Accordingly, the phase of the current vector i can be estimated based on the phase of the voltage vector v.

A peak value detection unit 121B according to the third embodiment estimates the phase of the current vector i on the basis of the phase of the voltage vector v, and detects the peak value ip by using appropriate correspondence relationship information 128B_1 and 128B_2 according to the shift width φ of the phase of the current vector i with respect to the phase of the voltage vector v.

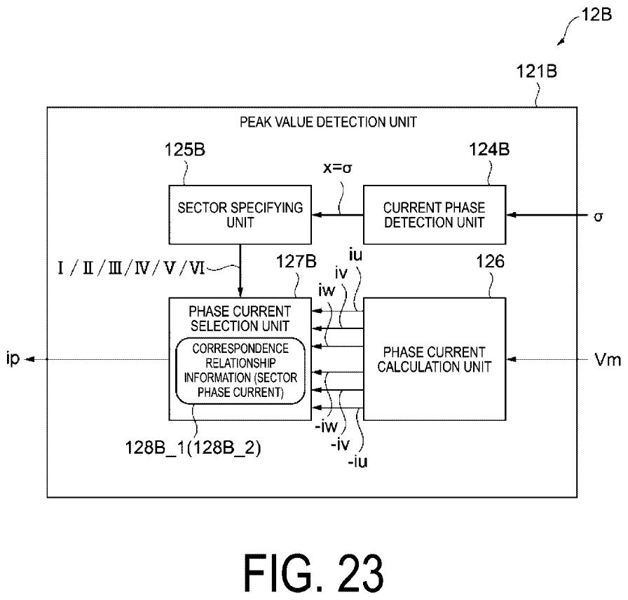

FIG. 23 is a diagram illustrating a configuration example of the peak value detection unit 121B according to the third embodiment.

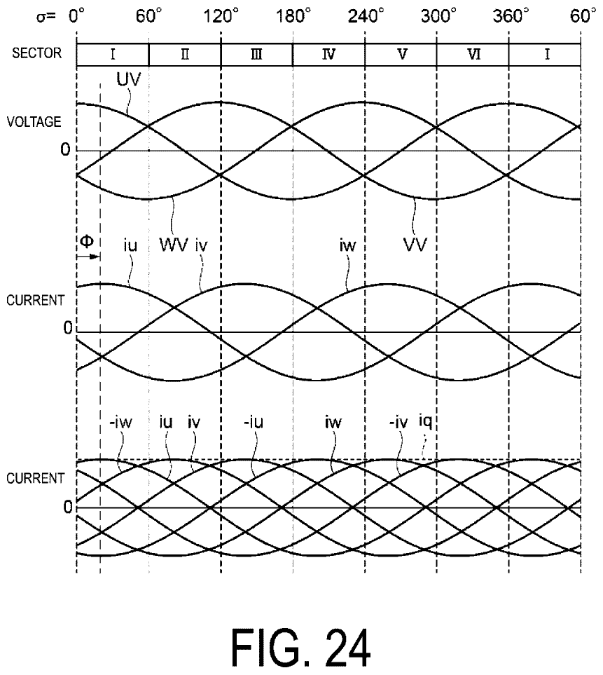

FIG. 24 is a diagram for explaining an overview of a method of estimating the q-axis current according to the third embodiment.

The upper part of FIG. 24 illustrates “sectors”, and the sectors are ranges obtained by dividing the range of the electrical angle from 0° to 360° into a plurality of sub-ranges. The middle part of FIG. 24 illustrates values UV, VV, and WV obtained by converting the voltage vector v represented by the voltage command value vref and the polar coordinate value of the angle σ (=θ+δ) into a three-phase (U, V, W) fixed coordinate system. The lower part of FIG. 24 illustrates the phase currents iu, iv, and iw, the phase currents −iu, −iv, and −iw obtained by inverting the polarities of the phase currents, and the q-axis current iq. In FIG. 24, a horizontal axis represents an electrical angle.

In the third embodiment, similarly to the second embodiment, the range of the electrical angle from 0° to 360° is divided into six sectors I to VI with reference to 0°. For example, as illustrated in FIG. 24, a range with the electrical angle X of 0°<X≤60° is set as the sector I, a range with the electrical angle X of 60°<X≤120° is set as the sector II, a range with the electrical angle X of 120°<X≤180° is set as the sector III, a range with the electrical angle X of 180°<X≤240° is set as the sector IV, a range with the electrical angle X of 240°<X≤300° is set as the sector V, and a range with the electrical angle X of 3000<X≤360° is set as the sector VI.

In a q-axis current calculation unit 12B, the peak value detection unit 121B detects the phase of the current vector i on the basis of the phase of the voltage vector v in the two-phase rotating coordinate system, the phase of the voltage vector v being calculated on the basis of the rotation angle θ of the rotor 31.

Specifically, first, a current phase detection unit 124B of the peak value detection unit 121B acquires the phase of the voltage vector v in the two-phase rotating coordinate system.

As described above, the drive control signal generation unit 22 converts the voltage vector v represented by the voltage command value vref and the polar coordinate value of the angle σ (=θ+δ) into a voltage signal (PWM signal) of the three-phase (U, V, W) fixed coordinate system by using a known space vector conversion computation method, and outputs the converted signal as the drive control signal Sd. That is, the phase of the voltage vector v is represented by a (=θ+δ).

In this regard, the current phase detection unit 124B acquires, as the phase of the voltage vector v, the angle σ (=θ+δ) output from the addition unit 21.

Moreover, the current phase detection unit 124B outputs the phase a of the voltage vector v as the phase of the current vector i.

A sector specifying unit 125B specifies a sector including the phase a of the current vector i detected by the current phase detection unit 124B. For example, as illustrated in FIG. 24, when the range of the electrical angle from 0 to 360° is divided into six sectors I to VI, the sector specifying unit 125B specifies the sector I, II, III, IV, V, or VI including the phase a of the current vector i, and outputs information on the specified sector.

A phase current selection unit 127B selects one phase current from a plurality of phase currents on the basis of the information on the sector including the phase of the current vector i, and outputs the selected phase current as the peak value ip.

As illustrated in FIG. 24, a phase current closest to the q-axis current in each sector varies depending on the shift width φ of the phase of the current vector i with respect to the phase of the voltage vector v. For example, when the shift width φ is in the range of −30°≤φ ≤+30°, two phase currents can be candidates for the peak value ip (q-axis current) in each sector. When the shift width φ is in the range of −30°≤φ≤+60°, three phase currents can be candidates for the peak value ip (q-axis current) in each sector.

Accordingly, in the third embodiment, similarly to the second embodiment, a plurality of phase currents serving as candidates for the peak value are associated with each sector in advance in consideration of the shift width φ of the phase of the current vector i with respect to the phase of the voltage vector v. Subsequently, the q-axis current calculation unit 12B compares the absolute values of the plurality of candidate phase currents in each sector with each other, and sets a phase current having the largest absolute value as the peak value ip.

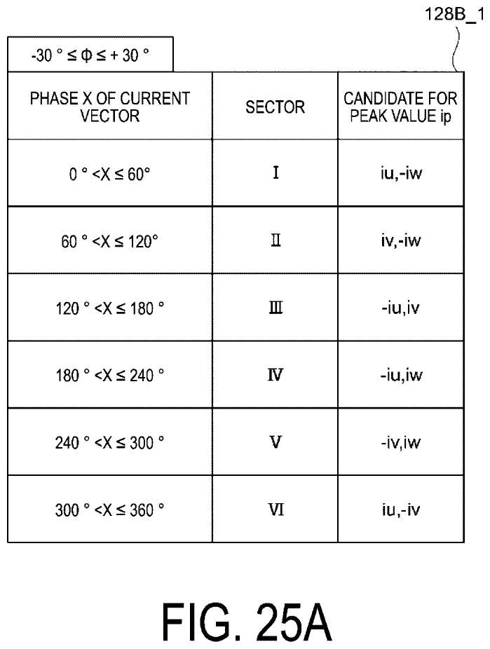

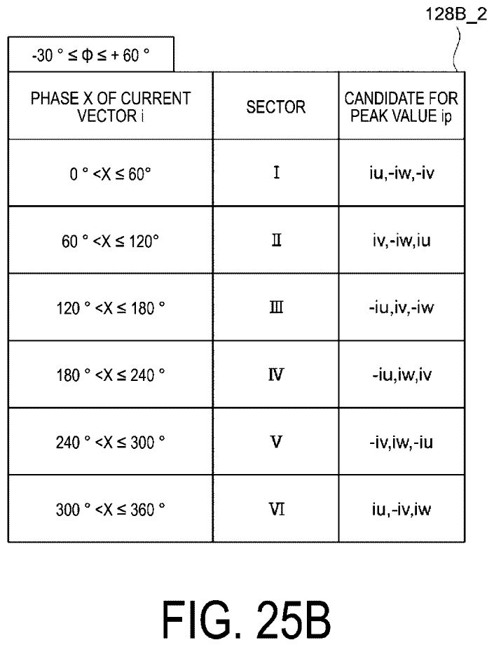

FIGS. 25A and 25B are diagrams illustrating an example of correspondence relationships between sectors and phase currents serving as candidates for the peak value ip in the third embodiment.

FIG. 25A illustrates correspondence relationship information 128B_1 between sectors and phase currents serving as candidates for the peak value ip (q-axis current) when the shift width φ is in the range of −30°≤φ≤+30°. FIG. 25B illustrates correspondence relationship information 128B_2 between sectors and phase currents serving as candidates for the peak value ip when the shift width φ is in the range of −30°≤φ≤+60°.

The correspondence relationships between the sectors and the phase currents serving as candidates for the peak value ip shown in FIGS. 25A and 25B are the same as the correspondence relationships between the sectors and the phase currents serving as candidates for the peak value ip according to the second embodiment shown in FIGS. 18A and 18B.

In the motor drive control device 10B, at least one of the correspondence relationship information 128B_1 shown in FIG. 25A and the correspondence relationship information 128B_2 shown in FIG. 25B is stored in advance at a storage device (for example, a nonvolatile storage device) of the control circuit 1B.

For example, after the motor drive control device 10B is activated, the phase current selection unit 127B reads the correspondence relationship information 128B_1 or the correspondence relationship information 128B_2 from the above storage device. The phase current selection unit 127B uses, as an argument, the sector including the phase of the current vector i specified by the sector specifying unit 125B, and selects a plurality of phase currents corresponding to the argument from the correspondence relationship information 128B_1 or the correspondence relationship information 128B_2 by a method similar to the method of the phase current selection unit 127A according to the second embodiment. The phase current selection unit 127B compares the absolute values of the plurality of selected phase currents with each other, and inputs a phase current having the largest absolute value to the low-pass filter 122 as the peak value ip. Processes after the low-pass filter 122 in the q-axis current calculation unit 12B are the same as the processes in the first and second embodiments.

In general, the shift width φ of the phase of the current vector i with respect to the phase of the voltage vector v increases as the rotation speed of the motor increases, and increases as the load (current of the coil) increases. Accordingly, in consideration of an application actually adopting the motor unit 100B, at least one of the correspondence relationship information 128B_1 and the correspondence relationship information 128B_2 may be stored in advance at the control circuit 1B.

For example, when the shift amount φ is assumed to be relatively small, the correspondence relationship information 128B_1 may be stored at the storage device of the control circuit 1B, and when the shift amount φ is assumed to be relatively large, the correspondence relationship information 128B_2 may be stored at the storage device of the control circuit 1i. Alternatively, both the correspondence relationship information 128B_1 and 128B_2 may be stored at the storage device of the control circuit 1, and the phase current selection unit 127B may read one of the correspondence relationship information from the storage device to detect the peak value ip.

As described above, the motor drive control device 10B according to the third embodiment can appropriately calculate the q-axis current while suppressing a computation load, similarly to the motor drive control devices 10 and 10A according to the first and second embodiments. In particular, since the peak value detection unit 121B estimates the phase of the current vector by using the phase a of the voltage vector v calculated in the course of the vector control computation, the computation load can be further reduced.

### Expansion of Embodiments

Although the invention made by the present inventor has been specifically described above on the basis of the embodiments, the present invention is not limited to the embodiments, and it goes without saying that the present invention can be changed in various ways within the scope not departing from the gist of the present invention.

For example, the first to third embodiments have described a case of calculating the rotation angle θ and the rotation speed ω of the rotor 31 on the basis of position detection signals from the position sensors 4u, 4v, and 4w; however, no such limitation is intended, and the rotation angle θ and the rotation speed ω may be calculated by a computation based on known sensorless control of a motor. In this case, the position sensors 4u, 4v, and 4w are not required.

In addition, the first to third embodiments have described a method of detecting the phase currents iu, iv, and iw by a shunt resistor connected in series to the inverter circuit 2a as the current detection circuit 2c; however, the phase currents iu, iv, and iw may be detected by other known current detection techniques. For example, the phase currents iu, iv, and iw may be detected by a shunt resistor provided between the coil of each phase and a common connection point of the drive transistors of the inverter circuit 2a connected to the coil (3-shunt method). That is, the method of detecting the phase currents iu, iv, and iw is not limited to the example described above, and various known current detection techniques capable of detecting a current flowing through the coil of each phase can be adopted.

In addition, the first to third embodiments have described a case of dividing the range of the electrical angle (0° to 360°) into six sectors; however, the number of sectors may be two or more and is not limited to six. The range of each sector (−30°<X≤30°, 0°<X≤60°, and the like) is not also limited to the example described above, and a desired range can be set as the range of each sector.

In addition, the method of calculating the voltage vector v (vref, σ) in the first to third embodiments is not limited to the example described above. That is, the voltage vector v (vref, σ) may be calculated by a known vector control computation.

In addition, in the case described in the first to third embodiments, the drive command signal Sc is the speed command signal Sc1 including a target value (target rotation speed) of the rotation speed of the motor 3; however, no such limitation is intended. For example, the drive command signal Sc may be a torque command signal specifying the torque of the motor 3.

In addition, the first to third embodiments have described a case of the motor 3 being the surface permanent magnet synchronous motor (SPMSM); however, no such limitation is intended. For example, even when the motor 3 is not the surface permanent magnet synchronous motor (SPMSM) (for example, when the motor 3 is an IPMSM), the motor drive control devices 10, 10A, and 10B according to the present embodiments can be used in a case of vector control being performed so that the command value of the d-axis current is always 0, without using a reluctance torque.

In addition, in the first to third embodiments, the control circuits 1, 1A, and 1B are not limited to the above-described circuit configurations. The control circuits 1, 1A, and 1B may adopt various circuit configurations configured to achieve the objects of the present invention.

The number of phases of the motor 3 driven by the motor drive control devices 10, 10A, and 10B in the first to third embodiments is not limited to three phases.

The above-described flowcharts are specific examples, and the flowcharts are not limitative. For example, other processes may be inserted between the steps, and the processes may be executed in parallel.

### REFERENCE SIGNS LIST

1, 1A, 1B Control circuit, 2 Drive circuit, 2a Inverter circuit, 2b Pre-drive circuit, 2c Current detection circuit, 3 Motor, 10 10A, 10B Motor drive control device, 11 Drive command acquisition unit, 12, 12A, 12B q-axis current calculation unit, 13 Computation unit, 14 Rotation angle acquisition unit, 15 Rotation speed acquisition unit, 16, 18 Error calculation unit, 17 q-axis current command value calculation unit, 19 Voltage command value calculation unit, 20 Lead angle control unit, 21 Addition unit, 22 Drive control signal generation unit, 100, 100A, 100B Motor unit, 121, 121A, 121B Peak value detection unit, 122 Low-pass filter, 123 Multiplication unit, 124, 124B Current phase detection unit, 125, 125A, 125B Sector specifying unit, 126 Phase current calculation unit, 127, 127A, 127B Phase current selection unit, 128, 128A_1, 128A_2, 128B_1, 128B_2 Correspondence relationship information (sector-phase current), 201 Correspondence relationship information, Q1 to Q6 Drive transistor, Sc Drive command signal, Sc1 Speed command signal, Sd Drive control signal, θ Rotation angle, ω Rotation speed, iq q-axis current, iqref Command value of q-axis current, vref Voltage command value, Vcc DC power supply, Vuu Vul Vvu Vvl Vwu Vwl Drive signal, Vm Current detection signal, ωref Target rotation speed.

1. A motor drive control device comprising:
a control circuit configured to output a drive control signal for driving a motor including multiphase coils; and
a drive circuit configured to drive the motor on the basis of the drive control signal output from the control circuit, wherein
the drive circuit includes:
an inverter circuit configured to drive the multiphase coils on the basis of the drive control signal; and
a current detection circuit configured to detect a current flowing through the multiphase coils and to output a current detection signal corresponding to the detected current, and
the control circuit is configured to:
acquire a drive command signal including a value indicating a target state of an operation of the motor;
detect, as a peak value, a phase current closest to a q-axis current of a two-phase rotating coordinate system when a d-axis current of the two-phase rotating coordinate system is set to 0 among phase currents flowing through the coils of respective phases and phase currents obtained by inverting the phases of the phase currents flowing through the coils of the respective phases by 180°, on the basis of the current detection signal and a rotation angle of a rotor of the motor, and to calculate the q-axis current when the d-axis current is set to 0, on the basis of an envelope of the peak value; and
generate the drive control signal by performing a vector control computation by using the q-axis current calculated, the drive command signal, a rotation speed of the rotor of the motor, and the rotation angle of the rotor.

2. The motor drive control device according to claim 1, wherein
the control circuit stores correspondence relationship information including sectors respectively associated with phase currents serving as candidates for the peak value, the sectors being obtained by dividing a range of an electrical angle according to a rotation of the rotor into a plurality of sub-ranges, and
the control circuit detects a phase of a current vector in the two-phase rotating coordinate system on the basis of the rotation angle of the rotor and the current detection signal, specifies the sector including the phase of the current vector, selects a candidate phase current associated with the specified sector on the basis of the correspondence relationship information, and sets the selected phase current as the peak value.

3. The motor drive control device according to claim 2, wherein,
when a plurality of candidate phase currents of the peak value are associated with the sectors, the control circuit compares absolute values of magnitudes of the plurality of candidate phase currents with each other, and sets a phase current having a largest absolute value as the peak value.

4. The motor drive control device according to claim 2, wherein
the control circuit sets a rotation angle obtained by adding π/2 to the rotation angle of the rotor as the phase of the current vector.

5. The motor drive control device according to claim 2, wherein
the control circuit detects the phase of the current vector on the basis of a phase of a voltage vector in the two-phase rotating coordinate system, the phase of the voltage vector being calculated on the basis of the rotation angle of the rotor.

6. The motor drive control device according to claim 1, wherein
the control circuit is configured to:
detect the peak value on the basis of the rotation angle of the rotor and the current detection signal;
a low-pass filter configured to receive the peak value input and detected; and
multiply a value output from the low-pass filter by a predetermined value, and to output a multiplication result as the q-axis current.

7. The motor drive control device according to claim 6, wherein
the predetermined value is π/3.

8. The motor drive control device according to claim 2, wherein
the sector is a range obtained by dividing a range of an electrical angle from 0° to 360° every 60°.

9. A motor drive control method comprising:
a first step of acquiring a drive command signal including a value indicating a target state of an operation of a motor including multiphase coils;
a second step of detecting currents flowing through the multiphase coils;
a third step of detecting, as a peak value, a phase current closest to a q-axis current of a two-phase rotating coordinate system when a d-axis current of the two-phase rotating coordinate system is set to 0 among phase currents flowing through the coils of respective phases and phase currents obtained by inverting the phases of the phase currents flowing through the coils of respective phases by 180°, on the basis of the currents detected in the second step and a rotation angle of a rotor of the motor, and calculating the q-axis current when the d-axis current is set to 0, on the basis of an envelope of the peak value; and
a fourth step of generating a drive control signal for driving the motor by performing a vector control computation by using the drive command signal acquired in the first step, the q-axis current calculated in the third step, a rotation speed of the rotor of the motor, and the rotation angle of the rotor.
